(19) United States
(12) Patent Application Publication
(10) Pub. No.: US 2007/0168462 A1
(43) Pub. Date: Jul. 19, 2007

(54) ONLINE PRODUCTION AND MEDIA COORDINATION PORTAL/SYSTEM FOR TELEPHONE RINGBACK MESSAGES AND DIGITAL MEDIA CONTENT

(76) Inventors: Jeffrey Adam Grossberg, Chicago, IL (US); Jon Victor Herrmann, Chicago, IL (US)

Correspondence Address: KEITH FRANTZ, 401 WEST STATE STREET, SUITE 200, ROCKFORD, IL, 61101, US

(21) Appl. No.: 11/624,670

(22) Filed: Jan. 18, 2007

Related U.S. Application Data
(60) Provisional application No. 60/760,010, filed on Jan. 18, 2006.

(51) Int. Cl. G06F 15/16

(52) U.S. Cl. 709/217

(57) ABSTRACT

The Invention is a multi-faceted web-based interface that includes such functional components as ringback message and other DMC sub-type production, ringback message and other DMC sub-type distribution, ringback subscriber, ringback caller, and other DMC sub-type user data evaluation, ringback and other DMC sub-type message valuation, single point online interface for diverse multi-users and objectives, and multi-adaptive formatting of ringback messages or other DMC sub-type messages for most cellular and land-line phone carriers' platforms. The Invention facilitates the production of a wide variety of ringback or other DMC sub-type audio, video and gaming message content such as: personalized information, advertisement and promotional offerings, and complex multiple segmented messages that utilize stock audio or video online content inventory combined with customized content or user provided content. The Invention's online interface and online production capabilities provide a highly efficient manner in which to create this variety of production output. The Invention also provides an online interface capable of formatting and gathering information from most telephone carriers. This capability allows the Invention to maintain a centralized database for storing ringback subscriber or other DMC sub-type user groups and ringback caller demographic information and in turn, the Invention provides national advertisers the ability to promote their advertisements on ringback subscriber messages across many carriers simultaneously. The Invention's dynamic “Ringback Coordination Center” bidding sector provides real time valuations of the advertising offerings between all parties, coordinating the most advantageous utilization of the ringback messages or other DMC sub-type messages for all parties concerned.

### CROSS-REFERENCES TO RELATED APPLICATIONS

This application claims the priority benefit of U.S. Provisional Patent Application No. 60/760,010, filed Jan. 18, 2006, the disclosure of which is incorporate herein by reference.

### INCORPORATION-BY-REFERENCE OF MATERIAL SUBMITTED ON A COMPACT DISC

Not Applicable.

### STATEMENT REGARDING FEDERALLY SPONSORED RESEARCH OR DEVELOPMENT

Not Applicable.

### BACKGROUND OF THE INVENTION

1. Field of Invention

The present invention relates to an online system and method for production, storage, distribution, valuation and marketing of ringback messages and other digital media content.

2. Background Art

A ringback message (sometimes referred to or also known as a ringback tone) replaces the standard ringing sound a caller hears as they wait for the called party to answer the line of the dialed number. Up to now, the primary replacement of such standard ringing has been music in nature, with a consumer subscriber base with a predominately 12-24 year old demographic profile.

The next evolution is using the ringback message for advertisements and promotional information, as well as incorporating more complex and creative productions that include multi-segment messages and video content. Furthermore, interactive games, push-button content requests, and many other features are being incorporated within the cellular, landline carriers' technical ringback implementation platforms.

A ringback (“RB”) message or ringback tone is in the form of audio or video digital format, and is one example of a number of types of a larger grouping called “digital media content” (“DMC”). Other examples of DMC are Voice or Video SMS, Ringtone Ads, Music Appended with Ads, as well as other examples. The overall definition of DMC is digital formatted content, either audio or video, that is used for the transfer of information, entertainment, advertising and or promotional or other message content.

The distinction between DMC sub-types are primarily centered around the manner in which the DMC content is delivered via the cell, line-line or alternative network. As contemplated in connection with the invention, it is the creation and or production and other aspects discussed herein of the DMC content that is of concern in the invention, not the delivery method over the network to the end user.

Options for Ringback Uses: As contemplated in connection with the invention, there are two major classifications for ringback messages: consumer class ringback messages and business class ringback messages. Each of these two classifications of ringback messages can require the same level of creative and complex production capabilities in creating a final typically approximate 28 second message. The major distinction between these two classifications is the focus of the content of the information being conveyed; the consumer class ringback focuses predominately on entertainment oriented content for the ringback caller, while the business class ringback focuses predominately on providing promotional information regarding business concerns, such as invoking desired action to build relations with the ringback caller, and or creating a pleasant calling experience for the ringback caller.

As contemplated in connection with the invention, there are two main kinds of business class ringbacks: 1st party business class ringback messages and 3rd party advertising class ringback messages. 1st party business class ringback application generally utilizes any of one's own company's employees' or cooperating associates' cellular or landline ringbacks to broadcast one's own company's promotional information. Anyone calling these numbers will typically hear specially prepared 20-28 second messages about one's business on one's own ringback service. 3rd party advertising class ringback application allows advertisers to utilize the ringback service of 3rd party ringback subscribers. The advertiser's content may range from being a portion of the ringback message as short as 5-8 seconds or being the entire 3rd party subscribers' ringback message as long as a 28 seconds.

It should be noted that the “consumer” and “business” designations, the “1^{st} party” and “3^{rd} party” designations, and like designations discussed herein refer generally to the entity to whom the ringback message or other DMC is intended for the purpose or service of, or the intended purchaser, customer, target audience or caller, and the like; and that such designations are arbitrary in nature in that they may be otherwise designated while remaining within the scope of the invention. It should also be noted that other forms of DMC can have varying lengths of messages and have a 1^{st} party or 3^{rd} party orientation in regards to advertising message content and the like while remaining within the scope of the invention.

Ringback Message Architecture: Today's standards allow up to 28 seconds of time in total for a subscriber's ringback message. Depending on one's specific carrier's technical settings, there is approximately 15 seconds of “prime time” in which a ringback message will start playing to anyone calling a number before one will start hearing the phone ringing. Thus, this prime time portion of the ringback message is guaranteed to be heard before the call can be answered. After another approximately 13 seconds, the unanswered call will be directed to one's phone's voice mail. The following breaks down message segments to a possible 1st party business class ringback message according to this current structure:

Preamble Segment: This segment encompasses the first 2-3 seconds of the ringback message and it is generally designed or intended to inform the ringback caller that they are hearing a ringback type message and usually identifies by name, the ringback subscriber or their business. Example: “Please enjoy the following message as we connect you to John Doe of the ABC company . . . ”. This segment can be used in a similar fashion for 3rd party advertiser ringback messages. This same holds true for other DMC sub-type user groups.

Prime Segment: This segment encompasses the next 10-15 seconds of the ringback message and it is generally designed or intended to provide the ringback caller with the most important promotional or other information. This segment is considered part of the prime time portion of the message since it will be heard by the ringback caller before the ringback subscriber is able to answer the call. This segment can be used in a similar fashion for 3rd party advertiser ringback messages in part or in whole. This same holds true for other DMC sub-type user groups.

Secondary Segment: This segment encompasses the next 10-13 seconds of the ringback message and it is generally designed or intended to provide the ringback caller with additional information that can be an extension of the Prime Section's information or can be of entirely different information, production quality and strategic purpose. An optional 2-3 seconds of this segment can be a reaffirmation of the ringback subscriber's name or other preparatory information as the call may be going to voice mail. This segment can be used in a similar fashion for 3rd party advertiser ringback messages in part or in whole. This same holds true for other DMC sub-type user groups.

Note: The content within a ringback message can include audio, video, games and special features, and any particular message may include sub-segments or more or less segments than identified above.

The following provides examples of the possible information focus for 1st party business class ringback content as well as the timing of how often these ringback messages will be programmed OR scheduled to be heard by ringback callers:

Individual Company Profile Message: This message type combines a customized Preamble Segment to greet the ringback callers along with a message segment with customized general company and/or personal information. This type of message is ideal for the emphasis of personal achievements, accreditations or company competitive factors. This message is not often changed, although a number of these type messages can be created in behalf of a ringback subscriber and rotated on a pre-determined basis. This same holds true for other DMC sub-type user groups.

Corporate Company Profile Message: This message type combines a customized Preamble Segment along with pre-produced Prime Segments that relate to one's affiliations with particular franchises, associations or corporations. This type of message is the most cost effective for production and enhances the ringback subscriber's reputation through national affiliation. This message is not often changed, although a number of these type messages can be created in behalf of a ringback subscriber and rotated on a pre-determined basis. This same holds true for other DMC sub-type user groups.

Company Promotional Program Message: This message type combines a customized Preamble Segment along with frequently changing promotional information such as weekly specials or rotating company general information. This message is intentionally often changed in order to provide a variety of information and calling experience for the ringback caller. This same holds true for other DMC sub-type user groups.

Infotainment Program Message: This message type combines a customized Preamble Segment along with an assortment of pre-produced program segments that can be frequently changed to encourage traffic to one's corporate website and entertainment freshness for repeated ringback callers. Examples of such varied programming can be Trivia, Local What's Happening, Tip of Day, Humor, Inspirational Quote of the Day, etc.

Note: Other DMC sub-types can fall within the aforementioned message architecture and objective, and alternate message arrangements, uses and purposes may be provided as desired.

Definitions: The following additional definitions are conceptually important to fully understanding the dynamics of the invention:

Ringback Message: The audio and/or video message that is heard and or seen by a calling party to the telephone number with implemented ringback service.

DMC sub-type messages: The audio and/or video message that is heard and or seen by a recipient of the particular DMC sub-type format

Ringback Subscriber: The individual who subscribes with their particular telephone carrier in order to obtain ringback or DMC service capabilities for their particular telephone number, be it cell or landline or 800#s and the like.

Ringback Subscriber Profile: The ringback subscriber's demographic, geographic and product preference information that in turn, may indicate their respective ringback caller's demographics orientation. The ringback subscriber profile is an indirect key indicator for measuring the appropriateness of a subscriber to a particular information or advertising campaign. This same holds true for other DMC sub-type user groups.

Ringback Subscriber Format: The kind of messages being presented on a ringback message service based upon the Ringback Subscriber Profile of the ringback owner. This same holds true for other DMC sub-type user groups.

Ringback Subscriber Collective: The grouping and pooling together of individual ringback subscribers that share similar attributes of their ringback subscriber profile. Ringback subscribers can belong to many different ringback subscriber collectives simultaneously.

Ringback Callers: Individuals who are calling ringback subscribers and hearing the subscriber's ringback messages. This same holds true for other DMC sub-type user groups.

Ringback Caller Profile: The index for the ringback caller's demographic, geographic and product preference information. The Profile is a direct key indicator for measuring the match/attractiveness to a particular advertising campaign. This same holds true for other DMC sub-type user groups.

Ringback Ad Campaign: The entire description and content involving the 3rd party advertising class ringback content (actual production), the ringback message schedule for the ads and the financial offering to ringback subscribers for the ringback air-time. This same holds true for other DMC sub-type user groups.

Ringback Air-Time: The time allocated on a ringback subscriber for any particular content, be it for 1st party or 3rd party promotion. This same holds true for other DMC sub-type user groups.

Short Form Content: Indicative to the ringback message as well as mobile media in general, short form content is material in either audio, video or interactive (game) form that is created specifically for a limited time duration (30 seconds to 7 minutes) to express information, entertainment (music, games, etc.), advertisement/promotion, and other programming (like sitcoms, PSA's, Jokes, News, etc.). Ringback message today is restricted to creating short form content of no more than 28 to 30 seconds.

Ringback Subscriber Cue: The content that is paid for and residing in a particular ringback subscriber's inventory within the carrier's system. This material can typically be rotated and scheduled for airing at will or on a random option (depending on the corresponding platform capabilities).

Ringback Coordination Center: The dynamic interacting sector of the Invention that acts as the clearinghouse for matching advertisers with ringback subscribers. This same holds true for other DMC sub-type user groups.

Ringback Ad Showcase: A component to the Invention's ringback coordination center that provides a database of past and current 3rd party advertising class ringback message productions that can be reviewed by ringback subscribers or other advertisers or other DMC sub-type users.

Carrier: The cellular and landline telephone carriers with their respective subscriber base. This same holds true for other DMC sub-type user groups.

Carrier Platform: The technical platform that allows for the Ringback capability for a particular carrier. There are a number of platform providers, each with their own set of technical parameters.

Cross Carrier: The ability for information, formatting of data, files transferred or other functionality to be available to a number of carriers at the same time.

Closed Garden: Certain carriers, mostly in the US, require their customers to purchase all services for their phone service/phone through the carrier directly, not allowing off line upload from outside parties, including the customers themselves.

Open Garden: Certain carriers, mostly outside of US, allow outside 3rd parties to upload content to the carrier's platform. Customers in this situation can purchase services and products outside the direct carrier channel, yet can be implemented on the carrier's platform.

Digital Media Content (“DMC”): The digital formatted content, either audio or video, used for the transfer of information, entertainment, advertising and or promotional or other message content. The distinction between DMC sub-types are primarily centered around the manner in which the DMC content is delivered via the cell, line-line or alternative network. As contemplated in connection with the invention, it is the creation/production of the DMC content that is of concern, not the delivery over the network to the end user.

Media Channel: Each sub-type of DMC involves a different way to distribute the content to the end user and functions as a “channel”. Multiple Media Channels can be used by modifying the DMC to conform to the particular production requirements of that particular Media Channel. Ringback Media is one Media Channel, whereas Voice SMS is another Media Channel.

There are currently a number of issues involving the creation of advanced multi-segmented ringback messages that lead to inefficiencies in production and impedes the utilization of business class ringback and other complex ringback messages. The following highlight a few of such issues:

Complex message production inefficiencies: Ringback message architecture and other DMC sub-types can involve numerous message segments and components that can be combined to create a more complete, yet complex presentation. Personalized preambles can be combined with 2 or 3 custom or pre-produced segments of various time lengths to result in one long message. An even more complex message production involves adding video components to the same message. In today's production environment, the only way one can achieve this level of production sophistication is to utilize extensive human intervention and production assistance; an actual hands on approach is needed to handling taking each segment and blending music and various components together to result in a professional produced final product. And the cost of such human intervened production process is relatively high, discouragingly high for attracting a larger base of ringback subscribers seeking this level of production sophistication.

At best, the current ringback platforms in place offer simple consumer oriented music selections within a carrier's limited inventory in a “Closed Garden” arrangement—not allowing customers to upload their own content directly. Very few carriers offer the ability to place a customer created “preamble” message before the music track selected. There are no provisions made to accommodate creating complex message formats or even business class ringback oriented advertisements. There is no comprehensive online production system that encompasses every aspect and component to producing a complex ringback message using predominantly self administered methodology, thus avoiding costly 3rd party hands on production assistance. This same holds true for other DMC sub-type user groups.

Carrier specific limitation: Currently, there is no centralized online means to produce ringback messages for various companies and consumers from different telephone carriers, store these messages in a centralized database and then distribute these messages to any number of targeted carriers. A national corporate client (be it 1st party business class or 3rd party advertising class) can not efficiently execute a national corporate presence across more than one carrier at a time. Each carrier has their own specific formatting issues and less than extensive production options, leaving a national client with difficult coordination for implementing a national program over the customer base of multiple carriers. This same holds true for other DMC sub-type user groups.

Carrier interdependence: Currently, most carrier ringback content offerings in the U.S. are only available within the carrier's system or platform (Closed Garden) and not available by a 3rd party outside company. In the case of ringback content, this current approach limits the choices for cost effective production that is generated directly in behalf of the client. This leads to the requirement of costly multiple productions of the same message in order utilize the customer base of multiple carriers. This same holds true for other DMC sub-type user groups.

Cultural and language limitations: Currently, there is no one centralized system capable of taking promotional, advertising or informational content and then translating, producing and distributing in multiple languages throughout various international areas. Such necessity will be a growing concern as callers of ringbacks and other DMC sub-types will demand more personalized message content in their most familiar language.

Ringback subscriber non-coordination: Currently, there is no way to accommodate the acquisition of demographic profile data for ringback subscribers, especially across carrier customer base, who may be interested in offering their ringback subscriber for use by a 3rd party advertiser. There is no way to coordinate the data and initiatives of different ringback subscribers from the same or different carriers to thoroughly accommodate a national advertiser's demands. This same holds true for other DMC sub-type user groups.

Ringback caller non-coordination: Currently, there is no way to accommodate the acquisition of demographic profile data for ringback callers, especially across carrier customer base, who may be interested in receiving more desirable/targeted ringback message content for a more favorable ringback calling experience. There is no way to coordinate the data and initiatives of different ringback callers from the same or different carriers to thoroughly accommodate a national advertiser's ad campaign. This same holds true for other DMC sub-type user groups.

Lack of 3rd party advertising class ringback message valuation: Currently, there is no way to appropriately assign and evaluate the monetary value of a ringback subscriber's message capacity/air-time according to their particular demographic and social-graphic profiles. There is no centralized system for providing an interactive marketplace that establishes a fair market value of the ringback message and other DMC sub-types. A national advertiser can not select specific demographic profiles, arrive at a monetary evaluation and present these offers to ringback subscriber owners, who in turn can review potential advertising ringback messages and their monetary offer for acceptance. The ringback message is unique in form compared to other broadcast and advertising media, and requires a special means to arrive a valuation, which is not currently being offered, in part or at all.

No multi-user interface: Currently, there is no online centralized means of accommodating all the needs of the various potential users of the various ringback applications and other DMC sub-types. This includes those interested in complex productions (be it business class or consumer class applications), in registering their ringback service (ringback subscribers), and those who are hearing ringback messages (ringback caller registration). Such lack of a centralized means leads to a slower rate of adaptations by the users for the creative use of ringback messages and limits the options available to the potential users within the marketplace.

No Central Media Channel Selection: Currently, there is no central means to select various Media Channels and respective different sub-types of DMC and obtain a centralized means to produce the specific formats of the DMC that correspond to said Media Channels. This leads to inefficiencies and low usage of said Media Channel and respective DMC format.

### SUMMARY OF THE INVENTION

To overcome the aforementioned limitations within the current market and technology state of art, the Invention offers a single online production system, portal and method that services the vast array of possible users as well as the participating parties involved in the implementation of ringback messages and other DMC sub-types, as referenced in FIG. 1 (general overview of all aspects of the Invention). The Invention is comprised of an extensive online user interface (such as via a graphical or text, browser-based or web-page format interface, utilizing hyperlinks, selection menus, buttons, and the like as may be termed or available for user interface, navigation and other purposes) and various functionality modules and databases hosted on servers accessible to the internet (and thus accessible to users of internet or intranet bi-communication devices such as MACS, PCs, PDAs, etc.). In addition to the extensive multifaceted Production Sector 170 dedicated to the production process of creating ringback messages and other DMC sub-types, the Invention offers the Ringback Coordination Center Sector 130; a dynamic means in which the supply and demand between advertisers and ringback subscribers and other DMC sub-types can arrive at a valuation for the media and implement ringback advertisement campaigns and other DMC sub-types advertising campaigns.

From a production point of view, the Invention considers every possible required component and necessary process involved in creating complex ringback message productions and other DMC sub-types, including maintaining online databases of pre-produced content 174. Using a user-friendly online admin area interface, every functionality from selection the specific Media Channels desired for DMC production 170.5, creating message copy 171, translation, choosing voice over talent 173, music selection 177, video selection 178, game selection 179, special features selection 180, mixing of content 181 and final multi-carrier formatting 183 is available to accommodate the various production needs of most any possible user group. Included is the selection of various Media Channels and respective DMC formats. The entire production process can be accomplished via the online resources (on a self-help basis) or additional hands-on assistance is available where needed. The Invention's online interface can tie into a single Carrier's customer base platform, or act completely independent of any particular carrier and thereby supporting the complete international array of possible ringback user groups and other DMC sub-type user groups.

From a distribution of content point of view, the final cross-culturally adapted product can be provided to carriers around the world, ideal for major advertisers looking for global exposure. And, from a cross-carrier file-formatting consideration, the Invention allows for the technical capability differences between carrier platforms; adjusting the deliverable message accordingly (some features may not be added or available because of inherent limitations within any one particular carrier's technical capabilities).

Via their own dedicated online private administrative area, the many possible user groups can access the Invention's functionality and resources expressly designed for their particular requirements:

The 1st party business class ringback user group and other DMC sub-type user groups have the benefit of many production options using the Invention. Utilizing the online production functionality (see FIG. 3 for more detail), the user can complete a wide range of message compositions including long form single messages to multi-segmented messages that incorporate stored pre-recorded material added to custom preambles. The Invention even allows for combining 1st party business class ringback messages with 3rd party advertising class ringback message segments to form “Hybrid” message content. While the output of a Hybrid message is the same as a typical 1st party business class ringback, the databases for the pre-produced material are distinctively different (175 vs. 140/405) as well the pricing and payment process (further detail in FIG. 4).

While a user can achieve all production processes online, with no need for outside hands on involvement, there is the option for advanced (personalized) assistance available at any time for any step along the way; such as connecting via email and or phone to an array of Service Providers such as voice over talent, music producers, video producers and professional copywriters.

The 3rd party advertising class ringback user group 140 and other DMC sub-type user groups have the benefit of utilizing all the options within the online production system in order to create more complex advertisement messages. Advertisers can upload via email or via FTP (file transfer protocol) their 3rd party advertising class ringback messages and other DMC sub-type messages (wave files or other compatible formats) into their own database storage area. Advertisers can also access and upload their off-line produced content or online produced content (using the Production Process Sector 170) to the Ringback Coordination Center Ad Showcase 140/405, making their inventory available to prospective ringback subscribers and Hybrid productions. The Ringback Coordination Center also allows the advertiser to enter online their “Format” preference 141 (via demographic and social-graphic profile forms organized in an online database) and engage in the valuation of their campaign using the Invention/the Ringback Coordination Center valuation interactive “Floor” 133 (see FIG. 4 for details). Coordinating the Format database information and the initiatives of a mass number of ringback subscribers across various carriers is accomplished, allowing for strategic placement of 3rd party advertising class ringback messages and other DMC sub-type messages along demographic profile lines across various carrier subscriber bases.

The ringback subscriber user group 120 or other DMC sub-type messages user groups have the benefit of providing via online forms, their format profile data to be pooled and organized in a central database using the online functionality of the Invention's Ringback Coordination Center area. The ringback subscriber's broadcast Profile or “Format” (based upon demographic and social-graphic profiles collected via online forms organized and stored in online databases) leads to monetary valuation on the part of those advertisers seeking those desired Profiles and Formats. Ringback subscribers can be coordinated by their relative Profiles/Formats to form ringback subscriber collectives that accomplish the profile/format preferences of a particular ringback advertising campaign. Monetary reconciliation based upon ringback performance is accomplished and credit provided from the advertiser to the various cross-carrier ringback subscribers. From a production point of view, a ringback subscriber may elect to utilize the Invention's extensive production functions to create a Hybrid ringback message that combines their own consumer or 1st party business class content with 3rd party advertising content.

The consumer creative ringback user group 190 and other DMC sub-type messages user groups have the same benefit for using the Invention's advanced production features within the production sector to create complex messages. Such complex messages incorporate pre-produced content (be it audio, video or gaming), add customized message segments and are stored within their assigned online database in the event of carrier transfer. The produced consumer creative ringbacks are available for use within the pre-produced content library 174 and Ad Showcase 405 with valuation benefit available to the creator/consumer.

The ringback caller register user group 110 has the benefit of providing via online form, their demographic information (profile/format) to the Invention's Ringback Coordination Center Centralized database 131. The profile/format information is collected and classified in a manner to provide more pertinent targeted ringback message content to the registered ringback callers (see FIG. 4 for details). The Ringback Coordination Center 130 can interface via data transfer over secure internet communication with a cross section of carriers to assist in the enablement of ringback callers to hear/see ringback messages that are more appealing, as well as regulate the content that certain registered ringback callers want to avoid. In doing so, ringback callers will receive more targeted messages, advertisers will have a higher level of confidence in reaching the ideal demographics and the ringback subscribers will receive a higher level of compensation for those ringback callers who hear their desired ringback messages.

The carriers 150 who participate with the Invention have the benefit of obtaining higher levels of income flow as the Invention stimulates the overall usage of ringback messages and other DMC sub-type messages, be it for consumer or business related applications and other DMC sub-type messages. The Invention provides the Carriers with a centralized online database that stores the performance activities of the ringback subscribers involved in national advertising campaigns (see FIG. 11 for more details).

The Service Providers user group 195 has the benefit of obtaining a centralized aggregation of the various other user groups that rely on Service Providers for assistance with production of ringback messages and other DMC sub-type messages. The Invention enables direct two-way communication between the Service Providers and those who require their assistance as well as a payment tracking system that provides an ease of reconciliation of Service Providers' clients' accounts. (See FIG. 10 for details)

Thus, the Invention accommodates the production needs of all participating parties, allowing for complex and multi-component productions with multi-cultural and cross carrier adaptations. At the same time, the Invention provides for the monetary evaluation of Ringback Stations and provides a dynamic marketplace for executing national/international advertising campaign via the utilization of ringback messages and other DMC sub-type messages.

Important advantages and benefits of the Invention include the following:

The Invention provides a centralized database for aggregating demographic information from a variety of national and international telephone carriers' ringback subscribers and ringback callers, and other DMC sub-type message user groups.

The Invention's centralized database of demographic information of telephone ringback subscribers and ringback callers enables advertisers to more widely utilize the ringback messages of a wider range of ringback subscribers from a variety of carriers in order to deploy national advertising campaigns with greater target market accuracy. This same holds true for other DMC sub-type user groups' data that can be centralized for advertisers.

The ability to more precisely target advertising messages to the most desirable ringback subscribers and ringback callers provides advertisers with greater quality exposure that leads to results in the form of higher sales of advertised products. This same holds true for other DMC sub-type user groups' data that can be centralized for advertisers.

The Invention leads to a greater return on advertising expenditures of the participating advertisers thereby increasing the utilization of ringback messages as a viable and valuable form of advertising and a greater proportional component to a company's total advertising and promotional budget. This same holds true for other DMC sub-type user groups.

The Invention's multi-formatting capabilities allow national and international business enterprises the efficient, accessible and simultaneous utilization of the ringback capabilities of a wide selection of different telephone carriers. This same holds true for other DMC sub-type user groups.

The Invention's ability to provide national and international business enterprises with a cross carrier promotional capability for their associated ringback messages results in a more complete and successful company wide promotional campaigns, leading to a higher usage of ringback messages by companies. This same holds true for other DMC sub-type user groups.

The higher utilization of the ringback messages for advertising and general business promotional use increases the profitability for the telephone carriers offering ringback message capabilities. This same holds true for other DMC sub-type user groups.

The Invention provides the ability for ringback subscribers and the advertising community to interact with each other in an ideal manner that facilitates a more accurate valuation of the worth of ringback messages for a wider variety of advertising campaigns and advertisement productions. This same holds true for other DMC sub-type user groups.

The Invention's ability to yield a more comprehensive and accurate valuation of ringback messages brings about a more profitable and stable income opportunity for ringback subscribers who make their ringback messages available to advertisers who promote 3rd party products and services. This same holds true for other DMC sub-type user groups.

The Invention's ability to track, store and analyze ringback subscriber caller history and performance data from a cross section of carriers results in a wider and more accurate range of valuation of advertising usage on ringback service. This same holds true for other DMC sub-type user groups.

The Invention provides more targeted and desirable ringback message content to ringback callers thereby resulting in the ringback callers' higher satisfaction with exposure to ringback messages. At the same time, the Invention can assist in protecting ringback callers from undesirable content and unwanted repeat messages. This same holds true for other DMC sub-type user groups.

The Invention's ability to creating a higher level of satisfaction of ringback callers leads to the more successful and increased overall utilization of ringback messages, yielding higher revenues to carriers and ringback subscribers. This same holds true for other DMC sub-type user groups.

The Invention provides a complete multi-component production system that accommodates the production of every possible aspect to creating complex ringback production, with all steps being accomplished online. This same holds true for other DMC sub-type user groups.

The Invention provides an extensive online production capability that allows for a highly efficient creation of a wide variety of different types of ringback messages. This same holds true for other DMC sub-type user groups.

The Invention's capabilities to reduce the cost of production of ringback messages leads to higher profitability by those utilizing the production and affords/attracts a wider range of users of ringback messages. This same holds true for other DMC sub-type user groups.

The Invention's ability to efficiently and conveniently offer a wider array of ringback message production output yields a higher level of satisfaction for ringback service subscribers, thereby attracting more users of ringback messages. This same holds true for other DMC sub-type user groups.

The Invention's online language translation capabilities provides a more easily attainable culturally diverse ringback production output, thereby appealing to a wider international ringback subscriber base. This same holds true for other DMC sub-type user groups.

The Invention's flexible user's system utilization configuration allows every user to customize their preferred manner in which they accesses the information and functionality of the entire system to best accomplish their goals and relative activity levels. This same holds true for other DMC sub-type user groups.

The Invention's alternative interface options allow users to access the capabilities of the Invention via cellular WAP interface as well as via voice prompted call center interface. This same holds true for other DMC sub-type user groups.

The Invention's multiple Media Channel selection and production formatting allows users to pick many different Media Channel distribution means and produce the different DMC sub-type formats associated with the respective Media Channels selected. One or all Media Channels can be selected and this results in high use of said Media Channels which creates more revenue for Carriers and their financial partners, and at the same time, lowers the average cost to produce said multiple formats of the DMC Sub-types.

The Invention's ability to import data on behalf of Ringback Subscribers regarding their specific callers enables special messages to be created for specific Ringback Callers of respective Ringback Subscribers. These Callers can receive any number of types of content and depth of content that increase the relevancy of the message to that particular Caller. Account information or specific offers can be directed based upon the imported data.

### BRIEF DESCRIPTION OF THE DRAWINGS

The present invention can be further understood by references to the following description and attached drawings that illustrate the components and details of the Invention. Other features and advantages will be highlighted from the following detailed description of the invention that is further supported by the attached drawings.

The following provides an overview to the various drawings and their relevance to the Invention:

FIG. 1 is an overall block diagram illustrating the entire structure and component constitution of the Invention.

FIG. 2 is a general block diagram illustrating the main Client Admin Area in detail.

FIG. 3 is a general block diagram illustrating the Production Process Sector in detail.

FIG. 4 is a general block diagram illustrating the Ringback Coordination Center Sector in detail.

FIG. 5 is a general block diagram illustrating the 1st Party Business Class Ringback Admin Area in detail.

FIG. 6 is a general block diagram illustrating the 3rd Party Advertising Class Ringback Admin Area in detail.

FIG. 7 is a general block diagram illustrating the Ringback Subscriber Admin Area in detail.

FIG. 8 is a general block diagram illustrating the Creative Consumer Ringback Admin Area in detail.

FIG. 9 is a general block diagram illustrating the Ringback Caller Register Admin Area in detail.

FIG. 10 is a general block diagram illustrating the Service Provider engagement in detail.

FIG. 11 is a general block diagram illustrating the Carrier & Platform engagement in detail.

FIG. 12 is a diagrammatic representation of user interaction with and certain additional aspects of the invention.

### DETAILED DESCRIPTION OF THE INVENTION

In the following description of the invention, reference is made to the accompanying drawings, which form a part thereof, and in which is shown by way of illustration a specific example whereby the Invention may be practiced. It is understood that other embodiments may be utilized and structural changes may be made and alternate methods practiced without departing from the scope of the present invention. It should also be noted that the invention is generally described and shown in the drawings in connection with ringback message media. However, in general, except as will be apparent to those skilled in the art, the designation of ringback messages, segments, subcomponents, and the like, can be replaced with other forms of DMC, thereby providing for the same aspects and features of the invention and corresponding benefits in relation to provision of applicable segments, subcomponents and the like of other DMC.

The Invention maximizes the overall usage of ringback messages and other DMC sub-type messages by providing a comprehensive online production system 170 (outlined below) as well as an interactive online coordination center 130 for the valuation of ringback messages. The Invention provides an online interconnected user interface to accommodate numerous potential user groups. The Invention connects all possible users of ringback messages and other DMC sub-type messages together with potentially every national and international cellular and landline Carrier. The Invention further connects Service Providers that support the creation of complex ringback messages and other DMC sub-type messages, and the implementation of 3rd party advertising class and 1st party business class usage of ringback messages and other DMC sub-type messages. In addition to the benefits of the online interface, the Invention incorporates numerous functionalities throughout the system such as but not limited to: online production functions (mixing multiple message segments, recording voice over, selecting music clips, etc.) to facilitate ringback messages production and other DMC sub-type message production, online interactive functionality (communication facilitation, data sharing, algorithmic processes) between user groups to arrive at valuation of ringback ad campaigns and other DMC sub-type message campaigns, cross-carrier adaptations functionality (in the file formatting and transfer protocol) for the final productions and execution of national/international advertising campaigns, and more functionality listed in detail below.

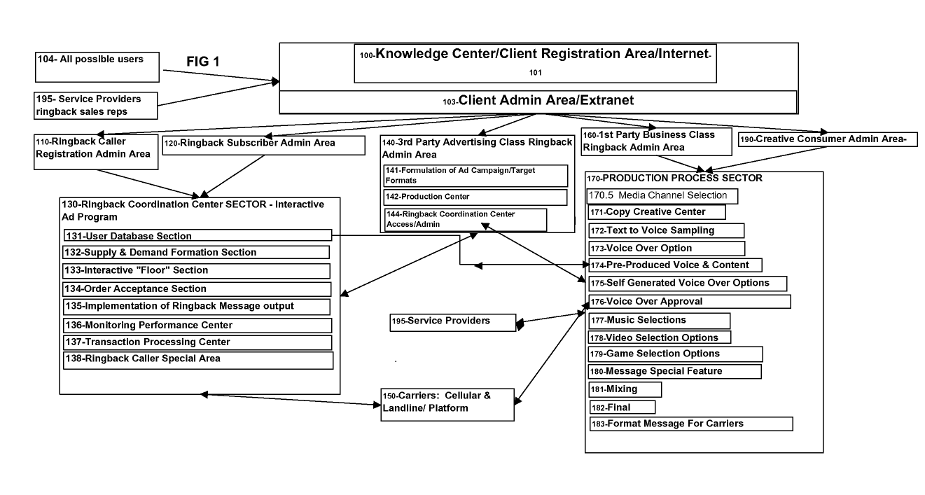

FIG. 1 is an overall block diagram illustrating the entire structure, component constitution and methodology of the Invention. The invention utilizes applicable software, hardware, firmware and the like to present user interfaces and otherwise effect the elements described herein. All users 104 enter online to the Invention's main homepage and begin their utilization of the Invention by entering (clicking to) a segment of the online interface called the Knowledge Center 100 whereby the user can access information regarding product knowledge, productions options, general pricing, definitions of terms, example demos, and clearly understand the user options and relative production path or other resources that are available. It should be noted that block 100 and certain other blocks, as will be evident in view of the present disclosure, are generally indicative of an appropriate user interface (e.g., browser based web page or the like) with applicable passive and interactive elements as discussed herein.

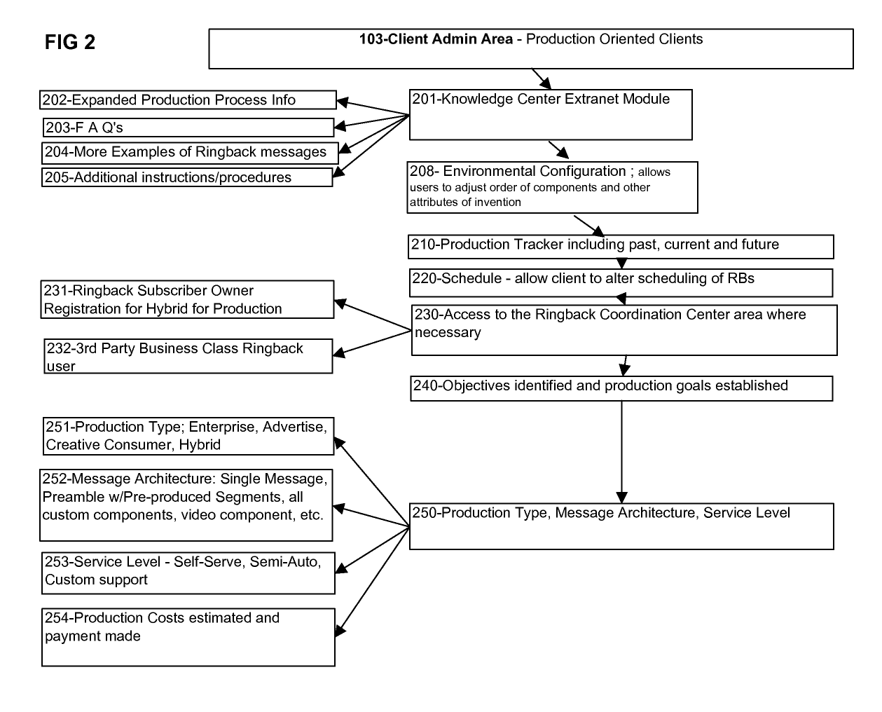

Once a user has determined their most appropriate user group affiliation, they may access (e.g., click through from menu interface) the Client Registration Area 101 where they establish a personal user account with password privilege to enter into a secured extranet section of the online interface where they provide contact information, including billing information (where appropriate). By way of private password protection, the user will have the benefit of accessing both the main Client Admin Area 103 (see FIG. 2 for details), as well their appropriate user defined admin area or areas (a user may opt to engage in multiple user applications). The Client Admin Area provides common needed support and info, and allows users to go from one private user group admin area to another in order to accomplish more hybrid productions when necessary. There is a master client account established via online assigned database that holds most common information amongst all users, and sub-database accounts are linked that are more user group defined to provide more specific database information pertaining to particular user group activities.

One important technology feature of the Invention is the Custom User Environment Configuration: The Invention provides, in the client admin area (see FIG. 2, area 208) or other selected admin area, users with means to configure the way they use the various components of the Invention. This aspect of the invention is implemented by an online selection of component choices and the order in which these components link together in succession throughout the Invention such as but not limited to the Production Process Sector 170 and the Coordination Center 130. The configuration allows every user to customize their preferred manner in which they access the information and functionality of the entire system to best accomplish their goals and relative activity levels, such as:

(1). Production Configurations: New users to serious users can adjust how they each use the production components; from the order in which they use them, the depth of access (from a serious in depth utilization to a quick breeze through), to the classification of the Media Storage Database items. Certain User may prefer to select their music background and then test various text to speech files with the music, as opposed to creating the voice over first without music.

(2). Coordination Center Configuration: Customizing communication alerts based on active level of involvement—highly active or low participation.

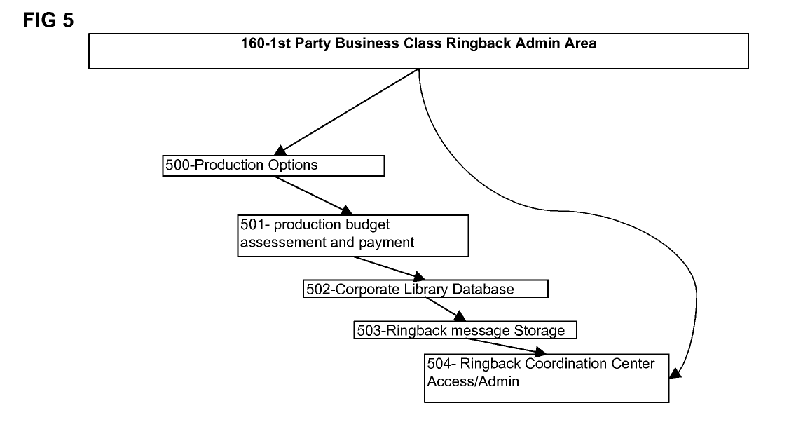

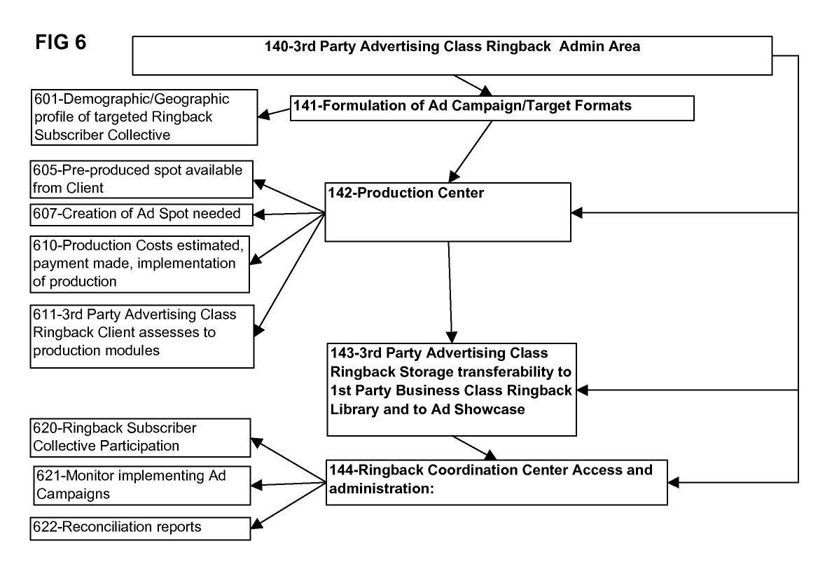

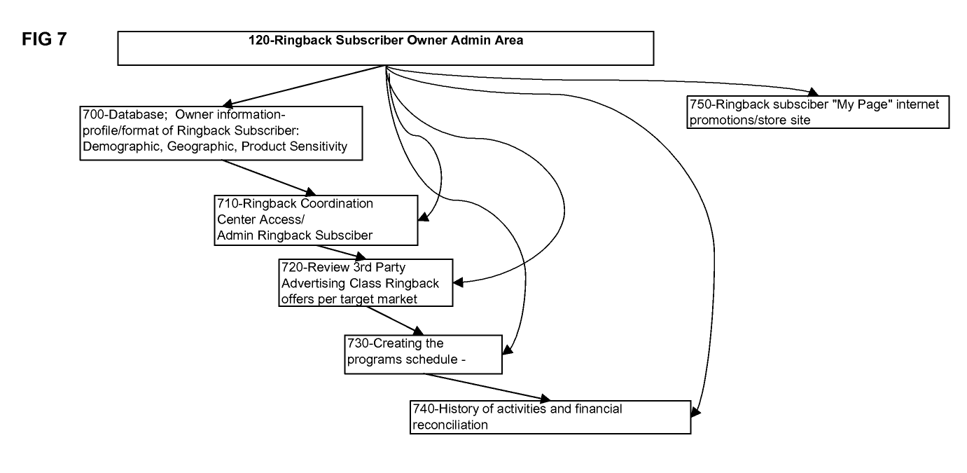

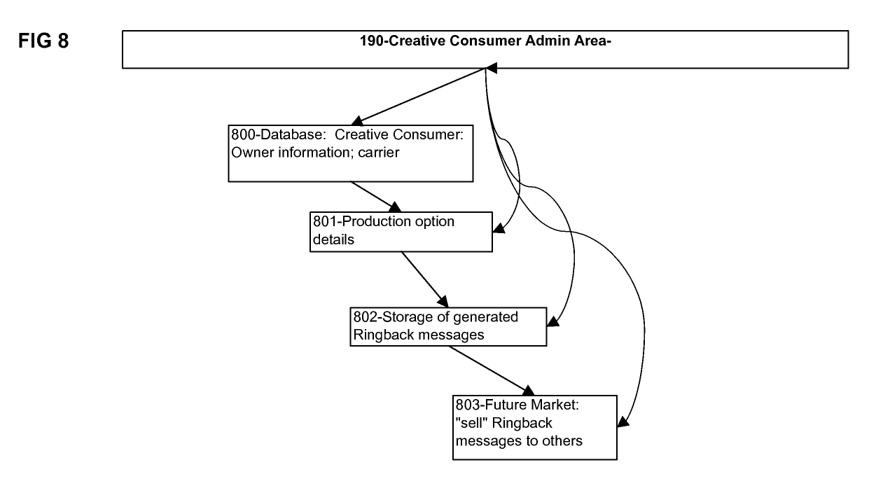

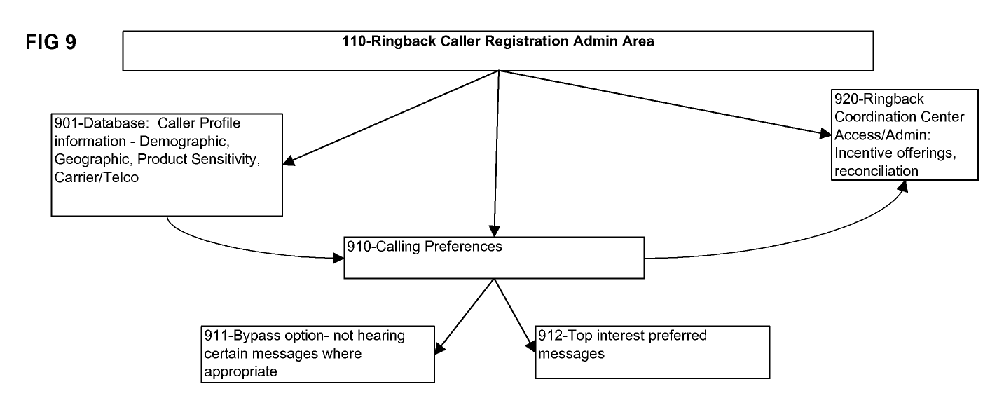

From the main online Client Admin Area 103, the user enters (e.g., select from or click through from menu interface) into one of the 5 possible User Production Path Admin Areas: The Ringback Caller Registration Client Admin area 110 (see FIG. 9 for details), Ringback Subscriber Owner Client Admin Area 120 (see FIG. 7 for details), 3rd Party Advertising Class Ringback Client Admin Area 140 (see FIG. 6 for details), 1st Party Business Class Ringback Admin Area 160 (see FIG. 5 for details), or the Creative Consumer Admin Area 190 (see FIG. 8 for details). Each has their own level of support and relevance as depicted in their respective detailed Figure drawings. Depending on their particular needs, each Client can access the necessary production features/functionality. For example, the 3rd Party Advertising Class Ringback Admin Area 140 provides an area for the Formulation of Ad Campaigns 141, a special Production center to store and access past productions, and access to the Ringback Coordination Center.

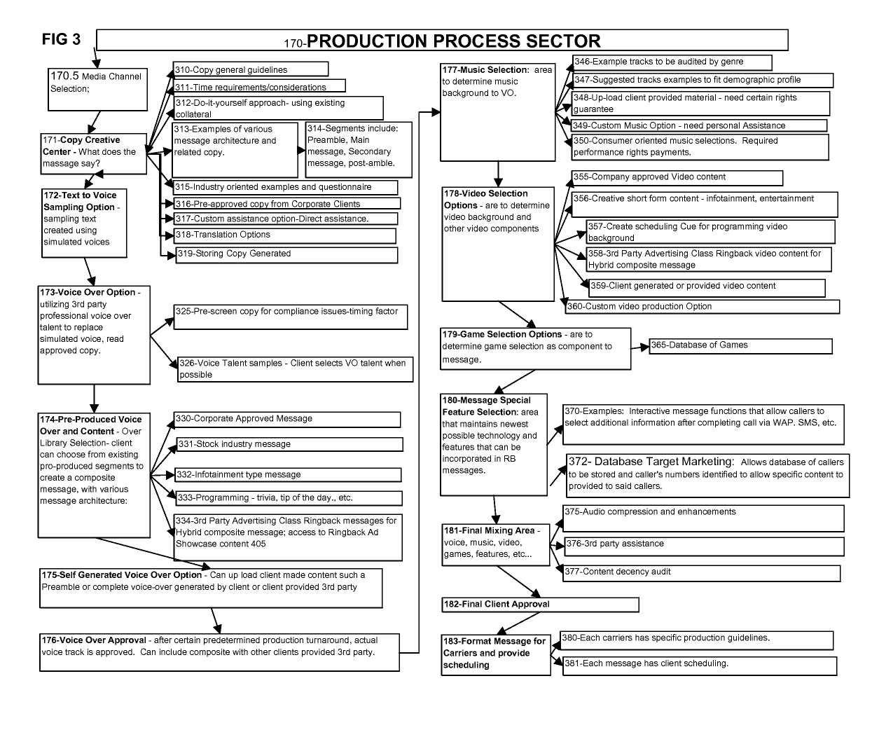

The Production Process Sector 170 is one of the main areas of the Invention (see FIG. 3 and relative explanation for more details). It is here where various user groups such as 1st Party Business Class, 3rd Party Advertising Class, 3rd Party Advertising Hybrid Class, Creative Consumers Clients/Users and other DMC sub-type user groups can access via the online production interface, the many phases of production such as creating Copy, Voice Over, Music, Video and more complex message architecture. The Production Process Sector allows a user to click through to the various production sections, each with their own built-in online interface that allows various functionalities to be utilized and production steps implemented to produce fully complete ringback messages and other DMC sub-type messages of various complexities without the need of outside, off-line assistance (see FIG. 3 for more detail). At any time, if more hands on assistance is required, a user can utilize online communication options such as email, real-time chat or telephone to engage live operators and independent Service Providers 195 or review an online Service Provider database with search capabilities to select and seek bids from Service Providers 1060. The production process includes pre-produced audio/video content that is stored in a database 174 that is available via online interface, allowing the user to preview audio/video content that can be considered for their particular production. Once selected, the desired content can then be added via online mixer with customized content that is generated through another online segment of the Production Sector 175 (see FIG. 3 for more details). The final ringback message output or other DMC sub-type messages is formatted and stored in an online database, ready for transfer via internet FTP (or other file transfer methods) to a complete cross section of Carriers 150; the output content is particularly adapted to the technical nuances of any particular Carrier Platform (see FIG. 3 for details).

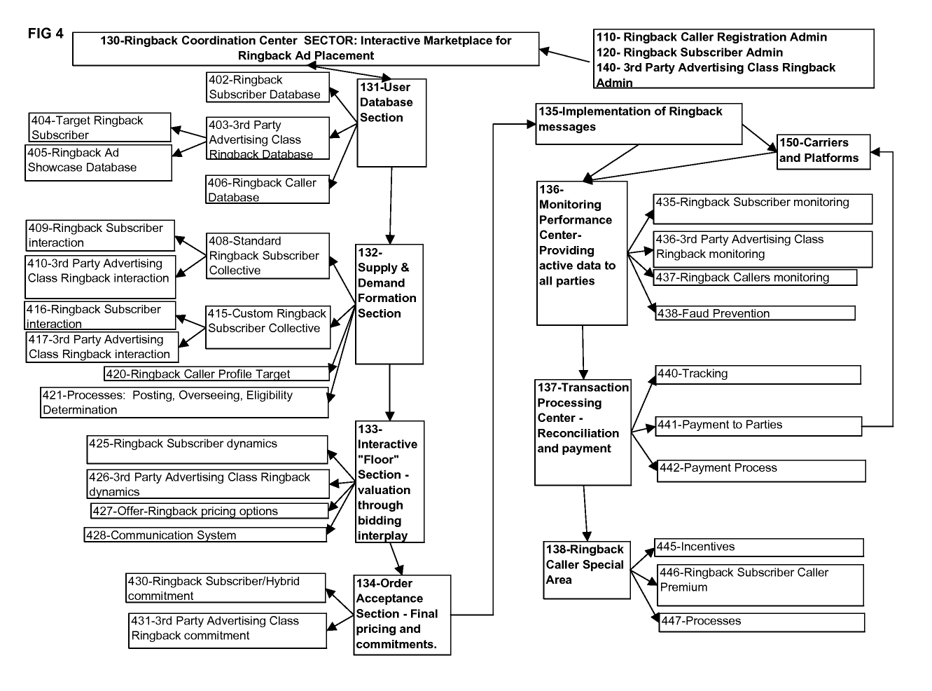

The Ringback Coordination Center Sector 130 is the other main area of the Invention (see FIG. 4 for details). It is at this online portion of the Invention where the ringback subscriber's or other DMC sub-type user group demographic and profile/format information is stored in an online database 131, evaluated and compared to the profile/format “wish list” of the 3rd party advertising class ringback clients. The ringback subscriber owners or other DMC sub-type user group can review possible 3rd party advertising class ringback messages or other DMC sub-type messages for their consideration within the online ringback ad showcase. This showcase allows audio and video files to be previewed online and stored within the user's admin area for future consideration and usage. Ringback subscriber collectives 132 can participate in certain designated ad campaigns, arriving at value through both specialized algorithms tailored to this new ringback message media, as well as a dynamic interactive Coordination Center “Floor” 133 that utilizes bidding and acceptance to determine the market value of certain grouped ringback subscriber collective air-time (see FIG. 4 for details). The Ringback Coordination Center can monitor the ringback broadcasts 136 achieved during the campaign (via data transfer from carriers, and collection/analysis of data) and arrive at issuing monetary credits where applicable 137. All transactions can be done across carrier 150, allowing for a national ad campaigns to take place. Subsequent details are presented in conjunction with the explanation of FIG. 4.

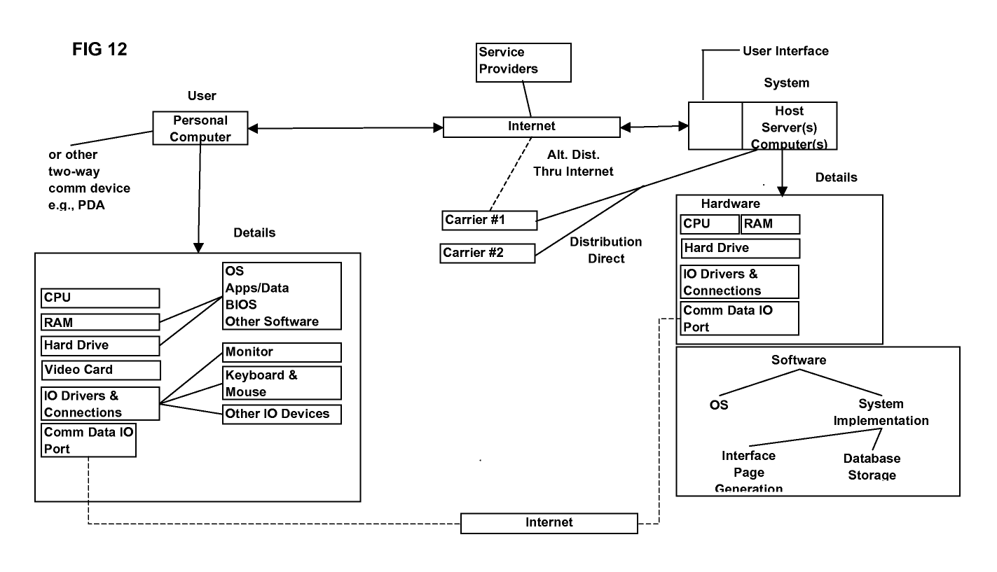

FIG. 2 depicts the subsections and details of the main Client Admin Area 103 that provides registered users with information/support through its online interface. Utilizing a click through menu interface, the Knowledge Center/Extranet Module 201 provides additional information in form of written words, diagrams, and voice over presentations regarding the production process 202 of ringback messages. Such information includes ringback message architecture options and other DMC sub-type message options, pricing options and assistance options. Frequently Asked Question section 203 provides additional information on various topics of popular interest. More Examples of ringback messages 204 and other DMC sub-type messages provides online demonstration of various types of productions (via audio and video players), and additional instructions 205 rounds out any remaining needed information in order to proceed with the process. The Environmental Configuration 208 allows clients to arrange the various components of the Invention in a manner that is best for their most appropriate and ease of use of the Invention. Further details provided in prior paragraphs above (0109-0111). The production tracker that consists of an online database 210, allows the user to review their past stored ringback messages and other DMC sub-type messages as well as checking the status of any productions in cue. Even future productions can be reserved in advance. The schedule module 220 allows clients to create the desired scheduling (when and how often a particular ringback message from within their performance cue will be played for ringback callers). Such scheduling can include multiple carriers at the same time where their particular ringback content is being presented. Not all carriers have the same flexibility when it comes to broadcasting certain ringback messages. The proper adaptation per carrier's capability can be accounted for and executed accordingly using the Invention's various formatting and tracking functionalities. Such scheduling information is available within the data record of the Call Performance Data Order, the details of which can be found in FIG. 12 below.

Within the Client Admin Area 103, a particular user may find it necessary to click through to access the Ringback Coordination Center 230 to register as a ringback subscriber 231 or enter as an 3rd party advertising class ringback user 232. The user is introduced to more information in order to establish solid objectives and production goals 240 and if need be, can access an online provided questionnaire that can assist the user to generate said goals. Production expectations are set 250 in regards to such information as: the desired production type 251 (1st Party Business Class, 3rd Party Advertising Class, Creative Consumer or Hybrid and other DMC sub-type message options) and the Message Architecture 252 being utilized (Single Message, Preamble w/Pre-produced Segments, all custom components, video components, games added, special features, etc.). Service Levels 253 can be outlined for the user ranging from the complete utilization of the online “self-serve” abilities to create ringback messages without off line human intervention or to higher services levels where there is the utilization of hands-on support where needed. And Production Costs 254 can be estimated via online calculation program (pulling data from the appropriate database available throughout the Invention and using certain formulas for the appropriate user group) and payment made prior to production via online payment portal (fully encrypted). The above-referenced online calculation program, and all other features, aspects and options referenced herein are provided with the Invention.

FIG. 3 depicts the various sections involving the Production Process Sector 170; the comprehensive multi-phased production “assembly line”. The user enters this highly functional sector of the Invention by way of clicking through from the appropriate online user group admin areas (160, 190, 140, or 120). Having predetermined their relative production requirements/objectives within the main client admin area 103/240, the user can select via a menu driven interface, the specific production components they require to meet their production objectives. Included is their selection of the corresponding level of service they require per production component, be it; “self-serve” (utilizing all the online functionality to create a ringback production and other DMC sub-type message options with limited outside intervention), semi-automatic (with some human hands on assistance) and fully assisted production.

As a first step for most any user is the selection for Media Channel 170.5. As a default, Ringback Media is used or selected, along with a possible selection of any number of other Media Channels and their respective DMC formats. One or all Media Channel options can be selected and new Media Channels can be added or subtracted by the user his or her selection depending on the its availability for the associated Carrier if appropriate. Once the desired Media Channels are selected, throughout the rest of the process, the Invention will alter the various stages of production selected by the User in order to accommodate the production requirements of the DMC format associated with said selected Media Channels. This can include changing the length of the final production, the placement of the message segments or the output formatting.

As an important step for those users requiring the generation of words used by voice over talent, the user enters (click through from menu interface) the online component of the Production Sector called the Copy Creative Center 171. Within this online section, a user can click through from a secondary menu interface to subcomponents like the Copy General Guidelines 310, with such displayed information as strategies on how to compile your own content (copy/text). More details are available in other subcomponents such as the Time Requirement section 311 where more guidelines are provided to ensure a rapid creation of copy by the part of the User. “Do-it-yourself” section 312 gives more specific suggestions on how users can extract appropriate ringback potential copy from their existing company collateral. Searchable from an online database, a user can view example copy various message architectures 313, including examples of the different message segments such as: Preambles, Main Message segments, and Secondary Message segments.

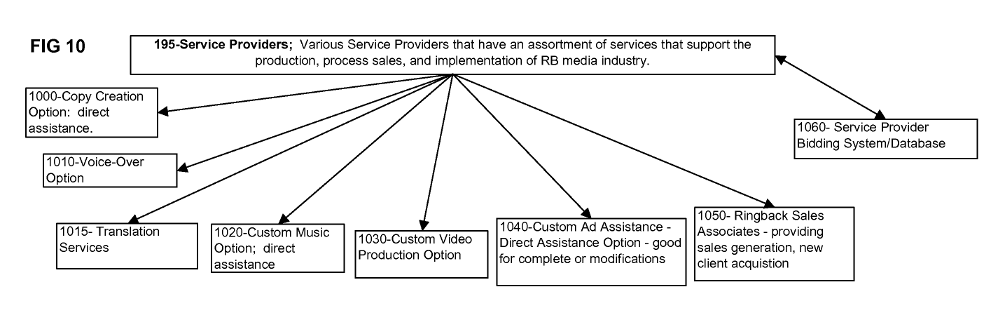

Further online assistance for self generating copy is given by providing a user with an easy to view interface of an online database consisting of industry oriented examples 315 of ringback potential message content/copy/words and other DMC sub-type message options. Special industry oriented online questionnaires (answers stored within a user's admin database) can be utilized by the user in order to present pertinent information of a particular business type. Pre-approved copy from existing Corporate Clients 316 is stored on an online data base and made available through a menu driven interface for users to expedite the selection of content that can be used by affiliates/employees/franchisees of larger entities. At any point in the copy creation process there is the option as listed within the interface for the user can utilize a number of communication channels (email, online chat, telephone) for direct hands-on assistance 317. Such assistance can include being connected to 3rd party participating Service Providers 195 who are available with their specialized skill sets. See FIG. 10 for more detail.

Depending on the manner in which the user has created their desired copy for their ringback message and other DMC sub-type message options, the copy is stored within the user's online admin database: If the user creates their copy using the online tools/subcomponents, the final copy is generated within a viewable area that temporarily stores the possible copy being considered, with an option for the user to select the ideal copy and then post within their online admin database. If the user uses outside assistance from Service Providers or has created their own preferred copy off line on their own, then there is a viewable area that a user can enter in (type in) the final desired copy or upload via navigational upload script, at which point the copy is then posted within the user's online admin database.

The user may upload a script in, for example, .doc or .txt format, or they can enter their text via an online form. Once the script has been uploaded or created the user provides special instructions and comments (can be generated by drop down options) and the item is added to their Media Storage Database. From this screen the user may also preview samples of Voice Talent from the Talent Library, and can specify the talent they would like to record their script.

Once a user's copy is successfully created and posted to their online database the desired copy for their ringback message, the user can click through using an online menu to the translation options 318 subcomponent. At this subcomponent, the stored desired ringback message copy and other DMC sub-type message copy can be selected for translation, followed by the selection of the desired languages for applying translation using a menu driven display of an array of various language options. Once the languages are selected, the target message copy is entered by way of internal script into the translation module that provides automatic translations similar to other online translation modules (such as Babelfish.org). As an additional option to the user, a Service Provider 195 can be accessed via email, online chat, or telephone in order to have additional translations of the same message. The final translation (be it created online or offline) allows the user to arrive at a more cross-cultural and geographic diverse message presentation. All of the user generated copy can be stored 319 in a Client/User data-library for future reference, accessible from their relative Admin Area.

Once all the desired copy (including the translated copy options) has been completed, the next subcomponent, the Text to Voice Sampling Option 172, allows the user to preview online the text being converted to simulated voice using text to voice technology. Computer scripting and online interface menu is used to offer the user preview options including the previewing of different types of voices (female, male, low, high, etc.). Online servers equipped with text to voice technology connected to the main online interface of the Invention are utilized to conduct the conversion of the desired ringback message copy/text into these previewed audio simulations or other DMC sub-type message options. The user may elect to save to their user online admin database the simulations generated to be used as the message content for their final message.

In the case of using simulations for testing/preview only, then the user may then click through to the next subcomponent called the Voice-Over Option 173—a menu driven interface that allows the user to preview potential professional voice-over talent, part of the Service Providers 195 supporting the entire production process. The User can further refine their choices with samples of the Voice Talent 326, making a selection for the most desirable voice option, then utilizing communication options (email, on-line chat, or telephone) to contact said voice over talent in order to obtain their assistance. Prior to submitting the desired copy to the targeted talent, a final Prescreen 325 can be employed to make final compliance checks such as time length issues (the online interface for this sub-section does provide message length display). With compliance parameters met, an order is placed via secured online communications with said voice-over talent, and any production charges are estimated, payment is secured through the online user admin area and the off-line production process is implemented using this professional voice over talent. Final voice over production is handled in subsequent subcomponents listed below.

Production Details: The following describes in more detail the means (used in various subcomponents of the Invention's Production Process Sector) in which audio and video content is stored, searched, previewed, uploaded, edited, compiled/mixed and formatted to formulate the final ringback message and other DMC sub-type message options that ultimately is heard by the ringback caller:

Source of Content: The following are a number of source options for a user to obtain the desired content components that any combination of which will comprise the user's final production:

1. Pre-produced content; Stored audio/video files are stored in online databases, such as: 174—Pre-produced Voice-Over, 177—Music Selection, 178—Video Selection, 179—Game Selection, 405—Ringback Ad Showcase. Using the online menu driven interface, the pre-produced content is searchable and can be previewed using standard file players (e.g., Windows Media Player, Flash based MP3 player). Using computer scripting, the selected desired content is then sent into production cue; loaded into ram of a server that host a multi-media authoring program such as but not limited to Marcromedia's Director MX 2004, Flash media player and other like programs. The Invention is able to accommodate any number of applicable 3rd party programs that are capable of providing the necessary functionality. The uniqueness of the Invention involves combining said programs with computer scripting (C++, Java, or similar scripting programs) that allow these 3rd party programs to be run without direct assistance by outside engineer. Instead, these programs rely on the predetermined production templates and routines that are scripted.

2. Off-line Self-produced or 3rd Party message content; For those users who have created their own desired message components off-line (outside of the Invention's system) and/or those users who obtain desired components from off-line 3rd Party Service Providers 173; this content created off-line can be uploaded by way of the online interface's file transfer program to the Invention's dedicated online computer server dedicated to production functionality, including a digital audio/video work station, special production scripting and production database. Using computer scripting, the selected desired content is then sent into production cue; loaded into ram of a server based multi-media authoring program such as Marcromedia's Director MX 2004.

3. On-line Self-Produced Material 175; Users may utilize such input devices as a telephone handset or computer based microphone to record their message voice-over content directly to the ram of the Invention's production server where it can be previewed for desirability. Using computer scripting to output ram content to file format, the selected desired content is then sent into production cue; loaded into server based multi-media authoring program such as Marcromedia's Director MX 2004.

Mixing Content: Using customized computer scripting, the desired components are loaded like multiple “tracks” into the multi-media authoring program/digital audio workstation (“Online Content Mixer”) that resides on a dedicated server that is tied into the main online server of the Invention. Pre-determined file management templates can provide certain appropriate functionality in accordance with the nature of the content. For example, a voice content track can be added to a back ground music track in a pre-determined manner such that a customized script can reduce the volume of the music track (lowering the decibels) where the two tracks intersect in time. EQ and other file/track enhancements can be added using customized scripting that measures certain desired indices of a particular content track and makes the appropriate adjustments to arrive at targeted qualities. For example; certain undesirable frequencies can be detected and reduced or eliminated with the proper EQ or compression adjustments. Each segment and component has a pre-assigned track placement and relative timing placement that coincides with its message architectural relevance, for example—a segment labeled as Preamble will be placed before a segment labeled as Main Section. Multiple tracks and components may comprise various architectural message design.

Final and Preview Options: A preview of the mix between all the content components/tracks can be provided to the user for their approval via the online interface media player which works in conjunction with the Online Content Mixer. One option for the user offers the mix to function as the final ringback message file that is multi-formatted for a number of carriers that in turn is uploaded for a particular ringback subscriber and other DMC sub-type message user groups. A second option for the user offers this mix to function as only a preview file that in turn can be exported with separate components as an EDL (Edit Decision List) formatted file and emailed to an off-line hands-on run “Production Facility. At that point, the EDL file would be imported into a Digital Audio Workstation and a hands-on final mix would be created in a more traditional fashion. Then the finished file would be uploaded back to the server for preview by the user who is notified by email. Any adjustments can be made to the final mix in accordance to the desires of the user—all edits would be accomplished in the similar fashion as the hands-on mix. The final approved production can be then multi-formatted for the numerous international carriers and uploaded to the appropriate ringback subscribers' cues.

It is important to note that while the Invention does accommodate sophisticated and complex ringback message mix capabilities performed without outside/off-line human intervention, a user can opt for more hands-on assistance with the mixing procedure in accordance to their personal desires and preferences.

The section entitled Technical Outline below provides additional details into important production processes of the Invention.

One of the major objectives of the Production Process Sector 170 is to provide the resources to enable the User to effortlessly and most flexibly combine together different message segments/components (consisting of different voice-over talent, music, message/copy content, video and gaming elements), creating the most appropriate final composite message as possible. This objective provides ringback messages and other DMC sub-type message options with more varied presentations (such as corporate company profile message, company promotional program message and infotainment program message), that can be easily “programmed” and scheduled to change in advance to allow for a varied listener experience. A different message can be presented daily on a ringback subscriber's message without incurring the high production costs associated without the aid of the online production processing of the Invention.

The primary area of the Production Process Sector that focuses on the producing variable programming content is the Pre-Produced Voice over and Content module 174. As part of the online interface with searchable menu feature, an extensive database storing various types of pre-produced message content can be easily searched for the appropriate content selection, searching by industry, corporate affiliation, content type etc. This includes audio as well as video and gaming material. The user enters the pre-produced content module and selects the more pertinent and desirable content for their ringback message content and other DMC sub-type message content. A content “shopping cart” can be utilized by the user whereby any possible message segments can be temporarily stored or more permanently stored within their own user admin area for review and final selection. This shopping cart categorizes the message segments as a function of their message architecture relevance (be a pre-amble, main or secondary segment).

The first main search category available to the user includes the Corporate Approved Message area 330 that stores within its online database different message segments that have already been created in behalf of a user's particular corporation, association or other affiliated specific entity. Through a password protected permission based access, only members/users of the same entity (company, associations, affiliation, etc.) can review their particular corporate approved pre-produced content. Regardless of the users' particular carrier or geographic orientation, the Invention's central database of pre-produced content can be shared amongst the different employees/affiliates of the same Corporation. Not all members/employees have the same carrier and therefore, the content would otherwise have to be duplicated and reformatted in a non-cost effective manner to be available for all the different carriers involved. The user can select desired segments and place in their content shopping cart for organizational and access purposes.

The second main search category is the Stock Industry message area 331 that stores within its online database different message segments with particular industry/vertical market message content orientation. The user can select desired segments that pertain to their particular industry and place in their content shopping cart for organizational and access purposes.

Other main search categories with their own searchable online databases are Infotainment type messages 332 such as local news material and the category of Programming material 333 like Trivia contests, Tip of the day, and other changeable content that can be utilized in a cost effective manner. The cost for the creation of the pre-produced stock material is amortized over a great number of Users, driving the cost and price down for any one User, while resulting in more interesting listening experiences for those calling the ringback messages or hearing/seeing other DMC sub-type message options. The user can select desired segments/programming and place in their content shopping cart for organizational and access purposes.

One other main search category of pre-produced message content is the 3rd Party Advertising Class Ringback Hybrid message 334. This online database is searchable for reviewing 3rd party advertising message content that is available for 1st party business class ringback user group 160 or creative consumer user group 190 (thereby creating a Hybrid production). This particular database is largely comprised of the content from the ringback ad showcase 405 that is filtered (data search with parameters of exclusion) to exclude any advertisers who have limitations to allow mixed Hybrid type content. Ultimately, any ringback subscriber who is creating a Hybrid ringback message will also be accessing the Ringback Coordination Center Sector 130 for valuations reasons (See FIG. 4 for more details). The user can select desired segments and place in their content shopping cart for organizational and access purposes. This same holds true for other DMC sub-type user groups.

Clicking through the online production process sector interface, the client/user can access another subcomponent of the Invention called the Self Generated Voice-Over Option 175. Utilizing this area's file up-load navigational feature, the user can upload from their computer any self produced voice over material or pre-produced message segments that may not reside in the Invention's online databases. This outside message content can be added to the user's content shopping cart for later inclusion into the user's final composite ringback message (like adding a customized self-produced or 3rd party produced preamble). This area also provides for the online creation of voice over content by the client/user in the manner of using input devices such as telephone handset or computer microphone whereby the user can record their voice content directly to the Invention's production server's ram and mixed into the final mix (see Production Details above).

For those Users who opted to utilize 3rd Party Service Providers 195 within the Voice-Over Option 173, (whereby user approved copy was transmitted via email message and the Service Providers created professional grade voice-over productions) the User can navigate via the Invention's online interface to click to the Voice Over Approval area 176. The participating Service Providers can upload from their computers via this area's file up-load navigational feature, the completed production for the user and send email notification to the user of the uploaded content residing within the online staging database for this subcomponent 173. The staging database allows temporary access by the participating Service Providers from content can be transferred by the user to their private online user database. The user can preview using online audio/video players the production of the Service Provider and then can transfer to private database and add acceptable content to the user's content shopping cart. The user may communicate (via email, online chat or telephone, or searchable database) with the Service Provider if further refinement is required, repeating the procedures outlined within the subcomponent 176 procedures.

Included in the material previewed within this area 176, are translated voice-over productions and added pre-produced or client produced composite segments that are pre-mixed/joined properly together in predetermined fashion. The ability to preview a mix between multiple segments is facilitated by the computer scripting that allows the user to select the particular desired message components residing in their content shopping cart and assign them to content tracks within the Online Content Mixer (see Production Details above for more information). Additional segments and components are assigned to the Online Content Mixer as the user continues to access the various subcomponent production modules.

Once the content from prior subcomponents is approved, the User can continue to utilize the online menu driven interface to click to/access the Music Selection area 177 whereby the online database of background music tracks can be searched. A number of subcomponents with their relative utility are available for the user, such as: Example tracks can be searched by genre and previewed with online media player 346, suggested tracks that fit certain demographics can be searched and previewed 347, 3rd party or User/Client music can be uploaded using this area's up-load navigational feature 348, and Consumer popular music selections 350 can be searched and previewed. And at anytime, 3rd Party Service Providers 349/195 are available to create completely customized music composition for the Users. These Service Providers operate in similar fashion as in other production areas; Users content Service Providers via email/online chat or telephone (or online searchable database 1060), a work order is created and end product, in this case music, is uploaded for the user to preview and changes are made where necessary in order to arrive at the finished production.

Whether using the music within the existing online databases, or 3rd party material, the desired music tracks can be stored in the User's content “shopping cart” as well as within their user admin area database for easy access in the future as well as a logged history of what has been used. These tracks can be loaded into the Online Content Mixer for further preview and adjustments.

Optionally adding more components to their ringback message or for other DMC sub-type messages, the user can enter via the online menu driven interface, the Video Selection area 178 that hosts an online database of various types of video material. The database is searchable with some pre-defined main categories such as: Pre-produced video content approved by Corporations/entities 355. This material is ideal for taking full advantage of high quality produced video that can be used by the many independent distributor/employee or affiliate of the Corporation/entity. Another category is Creative Short Form Content 356 that can be added as a video segment in keeping with the selected audio segments or running independently to the audio. Like its audio counterpart, the video content can be scheduled 357 for the benefit of low cost changeable content and 3rd party advertising class ringback video can be added 358 to create a Hybrid message. In fact, two different messages can be shown, one audio and one video, creating even more rich type options for the callers benefit. Client generated content 359 can be uploaded and stored. And, at anytime, the Custom video production option 360 to have assistance by Service Providers 195 is available.

The procedures and process in which the video production/mixing is achieved is in the same manner as the audio; ideal content is searched within in their relative online databases, previewed using online multimedia player, the desired video is saved to the users content shopping cart, then moved to the Online Content Mixer for refinement.

Optionally adding more components to their ringback message or for other DMC sub-type messages, the user can enter via the online menu driven interface, the Game Selection Option area 179 that allows the User to search the online Game database 365, preview via online game player and select various types of mobile oriented games that entertain ringback callers while they wait for the call to be answered. As in the case of the audio and video counterparts, the games component has similar content options—pre-produced content classified by corporate affiliation, industry specific, creative, 3rd party advertising, client generated, and ever changing programming material. Customized games can be created by Service Providers and uploaded in the similar fashion as audio and video content. Games can be mixed into the final produced ringback message or for other DMC sub-type messages using the Online Content Mixer, with its game management feature (special scripting that accommodates the integration of games into ringback message structure).

Optionally adding more components to their ringback message or for other DMC sub-type messages, the user can enter via the online menu driven interface, the Message Special Feature Area 180. At this point in the production process, the most state-of-art features and functionality can be incorporated into the ringback message being constructed within the active content shopping cart and Online Content Mixer. Such incorporation of special features takes into account the limitations of the various carrier platform technology levels. Some carrier platforms have inherent limitations on what special features can be implemented. This production subcomponent area provides various formatting options in accordance to the carriers' capabilities.

The user can access via online interface, examples of such Special Features 370 and their current carrier platform implementation status. An example of such a special feature is the interactive function that allows a ringback caller to select additional information by a push of a telephone button, or receive coupons via SMS text messages. Certain special features may be incorporated by the Invention within the ringback message independently of the carrier platform, whereas, other special features are more carrier platform integrated/dependent in which case the Invention will serve as the Special Feature showcase (example section 370) and provide the user request for service to the technically eligible carrier platforms.

Another Special Feature, Database Target Marketing 372, is the means, method or ability for outside databases to be uploaded and imported into the User's account/storage. This data can be used for a number of added value enhancements such as but not limited to: importing Ringback Callers specific data that can be used as part of the message content to specific Callers such as accounts information. Another form of data can be a list of favorite customer of a Ringback subscriber and thereby allow specific preambles to be created and caller ID technology used to provide a specific message to said special Ringback Callers. This same holds true for other DMC sub-type user groups.

In the final phases of the production process, after all the desired components are previewed, selected, and applicable 3rd party productions uploaded, the user via online interface enters the Final Mixing area 181. In this area, the user has the one option to utilize the current mix being provided by the Online Content Mixer as the final mix to which final online adjustments can be made, such as audio compression and EQ 375.

Or, the user may opt to contact a Service Provider by way of email/online chat/telephone/searchable database and utilize professional hands-on assistance to generates the desired blend between voice over, music bed, video content, games, and special features 376. the Invention provides an easy method (combination of computer scripting and file conversion) to export content from the Online Content Mixer via email and FTP to the Service Providers who in turn upload the files and conducts hands on mixing procedures within their production studio. Completed mixes are uploaded into the user's admin area and notification is sent to user via email.

In compliance with the participating carriers, an independent Content Decency Audit 377 is conducted to insure the compliance to established guidelines—this involves human review of final mix (online auditors can utilized the multi-media players for message playback and/or key word search can be conducted via hands-free scripting) and any issues are highlighted and the user is notified via email. The User can enter the Final Client Approval area 182 to make the final sign-off to the production provided by the Service Provider.

Once approved by the user, the content is then transferred (e.g., via internal scripting transfer files to other online database) to the Format Message area 183, along with the appropriate instructions for the carriers that will be receiving this particular production. Each carrier 150 will receive via email or FTP, the content formatted for their particular carrier platform as well as receive the appropriate guidelines 380 that are necessary to optimize the broadcast of the ringback on any particular Carrier or for other DMC sub-type messages. Scheduling of the ringback message or for other DMC sub-type messages is provided accordingly as well 381. Such scheduling information is available within the data record of the Call Performance Data Order, the details of which can be found in FIG. 12 below. All productions are saved to the User's admin database for future access and reformatting options. The User has the benefit of saving/storing their own productions prior to uploading to a specific carrier in the event that the user changes carriers and reformatting is required for the new carrier. And in the case of complex 3rd party advertising class ringback messages, they can be created, formatted and made available back to the pool of pre-produced content available to all users of the Invention, regardless of their carrier, cultural or geographic affiliation.

Note: Each different type of DMC has unique format considerations that can be addressed within the Invention such that the content being produced can be utilized for multiple different DMC by making the necessary alterations to the production in accord to the those specific DMC sub-types. This results in additional efficiencies and savings for the User.

Note: Additional information is provided below in the section entitled Technical Outline which includes further specific implementation of the Invention's Production Process Sector.

FIG. 4 depicts the subsections and details of the Ringback Coordination Center 130 that provides a dynamic real-time valuation center for buyers (Demand Side) and sellers (Supply Side) of ringback message space; the Advertisers seeking to utilize the ringback message or for other DMC sub-type messages (Demand Side) interact with the subscribers of ringback message service or users of other DMC sub-type messages who are interested in providing their ringback messages or their other DMC sub-type messages for 3rd Party Advertising Class Ringbacks (Supply Side). There are a number of important attributes addressed in the innovative architecture and technology utilized in this interactive Ringback Coordination Center Sector:

1. A centralized functionality and database that enables ringback subscribers or users of other DMC sub-type messages to opt-in, register and identify their interest in participating in offering their ringback message or their other DMC sub-type messages for advertising content. Centralization allows those ringback subscribers from different carriers to have a unified implementation of a national advertisement campaign.

2. A centralized functionality and database that extracts demographic and other valuable data pertaining to the participating ringback subscribers in order to create data profile or “format” for the ringback subscribers. Further functionality enables various groupings of similar subscriber profiles/formats to form larger ringback subscriber collectives or their other DMC sub-type messages user groups collectives that can provide targeted media campaigns for national advertisers.

3. A centralized functionality and database that identifies advertisers/3rd Party Advertising Class Ringback user group that are interested in particular ringback subscriber collectives with desirable formats. A desired targeted profile from the demand side can be identified and matched to those subscribers with such format profiles from the supply side to result in targeted advertising campaigns. This same holds true for other DMC sub-type user groups.

4. A centralized functionality and database that allows ringback subscribers the opportunity to review possible 3rd Party Advertising Class Ringback messages in order to achieve the subscribers' comprehensive evaluation of both the objective and subjective attributes of particular ringback messages. The objective attributes such as the financial considerations concerning a particular ringback message (what monetary implications are being offered by the advertiser to the ringback subscriber), as well as the subjective attributes such as the message's creative/content merits, provide the ringback subscriber with a more thorough perspective of the merits of any ringback ad campaign offering. This same holds true for other DMC sub-type user groups.

5. A centralized functionality and database that attract, registers and exacts demographic and other data from callers of ringback messages. National advertisers will be able to have direct targeted advertising campaigns to all registered ringback callers, even if the callers are being served by various carriers. This same holds true for other DMC sub-type user groups.

6. A centralized functionality and database that applies different levels of algorithms and evaluation processes to the data collected from the ringback subscriber formats, the advertisers' targeted formats, and the ringback caller profiles. This centralization translates various indexes into a common form valuation index that allows the parties (ringback subscriber, advertiser and ringback caller) to interact for the purposes of consummating the payment for ringback message advertising usage. This same holds true for other DMC sub-type user groups.

7. A centralized functionality and database that displays offers by advertisers in connection with their 3rd Party Advertising Class Ringbacks, and allow dynamic interaction with the ringback subscribers as they accept or counter offer. This interaction provides one means for generating the market pricing/valuation of an advertisement campaign. This same holds true for other DMC sub-type user groups.

8. A centralized functionality and database that monitors the broadcasts occurring during a said ringback ad campaign in order to protect the execution of the campaign from possible fraud. Fraudulent activities such as having bogus phone calls being generated in order to increase phone usage can be mitigated through the centralized reporting from the various carriers, and excluding the participation of certain ringback subscribers from the program who are involved with noted violations. This same holds true for other DMC sub-type user groups.

9. A centralized functionality and database that provides reporting, proper reconciliation and remuneration made to all appropriate parties (ringback subscribers, advertisers, ringback callers, carriers, etc.). This centralization enables discrepancies to be addressed in an impartial manner with fair and agreed upon universal guidelines. This centralization also offers more standardization and ease of use of certain aspects of the entire process, leading to a higher utilization of ringback media. This same holds true for other DMC sub-type user groups.

The aforementioned attributes comprise some of the core objectives and relative benefits of the Ringback Coordination Center Sector. The following describe in detail how these objectives are actualized through the utilization of the Invention's appropriate technology and infrastructure:

The Users enter (click through) the Ringback Coordination Center Sector 130 via their respective online Admin Areas; 3rd Party Advertising Class Ringback 140, Ringback Subscriber 120, 1st Party Business Class/Hybrid Ringback 160, or Ringback Caller 110. This same holds true for other DMC sub-type user groups. Each user group utilizes the Ringback Coordination Center in a different manner to meet their particular end objectives, as outlined below. It is important to note that within their relative online admin areas, each user group has entered via specialize online forms, the required data to complete the appropriate formatting and profiling files. Such data is stored within each of the user's personal online database that is interconnected with all users for conducting searches and compiled in various ways to necessitate the activities of the Coordination Center.

The first main area of the Ringback Coordination Center is the User Database Section 131 which stores via online databases, the collective data submitted to the Ringback Coordination Center by the various participating user groups as follows:

For the ringback subscriber user group, there is the Ringback Subscriber Profile/Format Database 402; the demographic and format data that is compiled from all the participating registered ringback subscribers from all of the cross section of carriers servicing the subscribers. The main objectives of the ringback subscriber using the Ringback Coordination Center are to maximize the value of their ringback message air-time and obtain aesthetically pleasing content where possible. This same holds true for other DMC sub-type user groups.

A ringback subscriber or other DMC sub-type user groups can be in various positions of participation at any given time, such as:

1. Closed: Registered but not available or interested in committing ringback air-time to any ad campaigns at the moment.

2. Open: Open to receiving offers from advertisers and ready to participate with the right campaign/offer.

3. Active: Actively involved and associated with one or more ringback subscriber collectives that is in the process of finalizing the terms of commitment with advertisers. This same holds true for other DMC sub-type user groups.

4. Committed: Conducting broadcasts of ringback messages associated with one or more ad campaigns and have a certain commitment in term/length of broadcast.

5. Commit-Open: Currently broadcasting ad content on their ringback message air-time, but are open to receiving other bids that may yield a higher return for their air-time. This same holds true for other DMC sub-type user groups.

For the advertisers user group, there is the 3rd Party Advertising Class Ringback Database area 403 that is comprised of two main sections, the first being Target Ringback Subscriber Format Profile Database 404; data that describes and targets particular hypothetical Ringback Subscriber Profiles/Formats that are most desired for implementing the advertisers' potential advertising campaigns. Advertisers compose their “wish lists” in terms of ideal target demographics as reflected in possible desirable ringback subscriber profiles/formats. This leads to the formation of custom ringback subscriber collectives (see 415 reference below). The objective of the advertiser user group is to reach the most desirable target market amongst the participating ringback subscribers at the lowest price possible and/or obtain the highest return in the form of total exposure to the desired target subscribers and ringback callers. In some cases, the advertiser's return can be measured in sales of product (see 427 pricing options). This same holds true for other DMC sub-type user groups.

Note: The aforementioned 3rd Party Advertising Class Ringback Database utilizes algorithms that have flexible sensitivity measurements such that an advertiser can widen the range of their parameters in order to allow a larger subset of eligible ringback subscriber participants. In this manner, a tighter, targeted format profile can be first sought and widen depending on number of participants needed for entire campaign. All these changes are conducted via the online interface within the advertiser user group admin area. This same holds true for other DMC sub-type user groups.

In this area of the Invention 403, the certification of the wherewithal of the advertisers can be made through posting advertisement deposits with the Ringback Coordination Center before entering the next stages of the Invention's Center. Do note that any advertisers can be “a member in good standing” based upon ad deposits on file, payment history and other measurable indexes. Said deposits are held in escrow in behalf of the participating advertisers and reconciled as a function of the processing center activities 137.

The second main section of the 3rd Party Advertising Class Database is the Ringback Ad Showcase Database 405: A centralize online database depository for all candidate ad content for potential ad campaigns. This ad content (audio, video, gaming message segments) is uploaded by potential advertisers via online file upload interface, stored with an online database and is searchable by ringback subscribers for content attributes (aesthetics and subject matter) and monetary/terms desirability for consideration to commit ringback air-time to said ad campaign. Via online menu-driven interface, ringback subscribers conduct, for example, the following activities relating to the Ringback Ad Showcase:

1. Review the artistic merits of ringback advertising messages—audio and video desirability. This same holds true for other DMC sub-type user groups.

2. Review on the basis of monetary offer—how much is being offered for ringback air-time. This same holds true for other DMC sub-type user groups.

3. Review on the criteria set by ringback advertiser—such as message restrictions, scheduling etc. This same holds true for other DMC sub-type user groups.

4. Search messages by industry, subject matter, product category, etc.

The Ringback Ad Showcase offers a feedback review from ringback subscribers to advertisers regarding the appeal of the presented ringback advertising messages. The Ringback Ad Showcase allows ringback subscribers to select (via online menu driven interface that compiles viewers' ratings), those “spots” that are most appealing while at the same time, provides advertisers (by way of emailed online forms) valuable feedback on the quality/appeal level of their particular ad productions. This allows advertisers to provide various production options for their 3rd Party Advertising Class Ringback messages and/or hone in on the best most acceptable, highest rated ad productions for targeted ringback subscribers. This same holds true for other DMC sub-type user groups.

Note: A 1st Party Business Class Ringback user may elect to incorporate a 3rd party ad message segment along with their 1st Party Business Class message segment in a Hybrid fashion. Thus, the 1st Party Business Class user would elect to enter as a Ringback Subscriber user as well and participate in the Ringback Coordination Center from that user group perspective. There can be certain ad messages and corresponding advertisers who restrict certain combinations of their 3rd party ad content with a potential 1st party ad—Hybrid ad participants are subject to review by these type advertisers. This same holds true for other DMC sub-type user groups.

For the Ringback Caller user group, the Ringback Caller Profile Database 406 provides collective Ringback Caller Profile data from all registered Ringback Callers via their online user group admin area. The objectives of the ringback caller are to receive the most pertinent ringback message content (subject matter, demographically oriented, aesthetically pleasing, etc.) and maximize their possible monetary benefits in the processes of being exposed to advertising messages. The centralized ringback caller data will be accessed by carrier platforms via online updateable disseminated databases transferred to the telephone carriers in order to identify callers and their profiles that in turn result in different and most desirable ringback messages being played to that particular caller (see 137 for more detail). This same holds true for other DMC sub-type user groups.

Moving on to the Supply & Demand Formation Section 132 where larger groupings of ringback subscribers called Ringback Subscriber Collectives are formulated using database search criteria, participants electronically “enlist” within possible active Collectives and communication of possible Collectives are posted online for participants' review (as detailed below). The Ringback Subscriber Collectives represent various groups of ringback subscribers, each with a common set of data attributes such as demographic, geographic, product orientation, industry category or other tangible qualities amongst a particular Ringback Subscriber Collective membership. A single ringback subscriber can qualify and belong to multiple Ringback Subscriber Collectives at any one time (each with different data attributes), with varying participation levels depending on their current set of ringback air-time commitments. An individual ringback subscriber qualifies to participate within any particular Ringback Subscriber Collective if the subscriber's particular ringback profile/format data falls within the scope of that particular Ringback Subscriber Collective's profile/format parameters. This same holds true for other DMC sub-type user groups.

The creation/formation of Ringback Subscriber Collectives can be driven by the demand side; advertisers seeking certain Ringback Subscriber Collective with desirable target attributes (“Custom Subscriber Collectives” 415), or by the supply side: pre-determined “popular” attribute combinations populated by ringback subscribers awaiting an advertiser to commit (“Standard Subscriber Collectives” 408, detail to follow). This same holds true for other DMC sub-type user groups.

The following is a more specific explanation of Standard Subscriber Collectives 408, starting with the subcomponent activity that pertains to ringback subscribers seeking to participate within a Standard Subscriber Collective 409: Standard Subscriber Collectives have certain pre-determined Formats that are appealing to the Advertising community at large. Teens, “Yuppies”, Senior Citizens, etc. are typical “stock” or Standard Subscriber Collectives that have standing opening for ringback subscriber participants. Via the online interface of this subcomponent, individual Active and qualified ringback subscribers may register their interest to participate for certain Standard Subscriber Collectives that are open and awaiting both more Collective members and active advertisers interested in initiating ad campaigns centered around these Standard Subscriber Collectives. A particular ringback subscriber may qualify for more than one Standard Subscriber Collective. The ringback subscriber's particular admin area with personal database allows for the tracking of their simultaneous involvements with multiple Collectives at what ever level of participation. This same holds true for other DMC sub-type user groups.

The following pertains to the activities associated with advertisers/3rd Party Advertising Class Ringbacks interested in Standard Subscriber Collectives 410: the Standard Subscriber Collectives represent a faster means by which an advertiser may launch an ad campaign that may have time sensitivity and broader, less stringent Profile/Format requirements. Standard Subscriber Collectives that have active members are posted for search in a listing section viewable via the online interface of this subcomponent. Prospective Advertisers can search the parameters of those active Standard Subscriber Collectives to lock (advertiser makes commitment to Collective) and implement an appropriate Ad campaign (upload advertising messages on Collective members' ringback service—details to follow). Advertisers can utilize all or a portion of the total active members of any particular Standard Subscriber Collective. Utilization entails making a commitment via the communication tools within online interface's interactive floor (see 133 below for more details). This same holds true for other DMC sub-type user groups.

The following is a more specific explanation of Custom Subscriber Collectives 415 starting with the subcomponent activity that pertains to advertisers/3rd Party Advertising Class Ringbacks 417; Utilizing an online profile form stored amongst the other advertisers' data that comprise the 3rd Party Advertising Class Database 403, individual advertisers create their desired “Target” Ringback Subscriber Profile/Format that includes other parameters (Budget, Scheduling, Restrictions, Data Sensitivity etc.) that describe and identify the ultimate Custom Subscriber Collective for their particular Ad Campaign. Once a solid description is generated for their desired Collective, and the advertiser has been certified a member in good standing, the advertiser may proceed to place the “order” that is electronically posted via online interface within this subcomponent area and ready for review by the active ringback subscribers seeking to participate in this potential Custom Subscriber Collective. This all holds true for other DMC sub-type user groups.

The following pertains to the activities associated with ringback subscribers interested in Custom Subscriber Collectives 416: the Custom Subscriber Collectives may generally represent more precise profile/format parameters that lead to higher valuation than Standard Subscriber Collectives in benefit of the ringback subscribers. And since the Custom Subscriber Collectives are driven by specific advertisers seeking to commit to their particular ad campaign, these Custom Subscriber Collectives are more likely to be activated and implemented. The potential of any Custom Subscriber Collective is realized once there are a critical number (predetermined in advance) of subscribers willing to commit to a particular Collective. Subscribers can access via their admin area online interface, the listings of Custom Subscriber Collectives seeking membership. An interested Subscriber can perform a data comparison query to the appropriate online database that can compare their particular subscriber profile with the desired profile parameters of the listed Custom Subscriber Collective to determine which particular Collectives does the Subscriber match and qualify. The subscriber can then proceed through the online interface to the Interactive Floor 133 and continue the process whereby they can obtain a membership within the Custom Subscriber Collective at an interactively determined valuation (details to follow, see 133). This all holds true for other DMC sub-type user groups.

The following pertains to the activities associated with the Ringback Caller Profile Target 420: Generally speaking, a ringback subscriber will be compensated to a higher level for calls to their particular ringback message service by identified ringback callers with the desired qualifying ringback caller profiles (“Ringback Caller Profile Targets”). The parameters for these Ringback Caller Profile Targets are generated to coincide with their corresponding Custom or Standard Subscriber Collective Profile/Format. Utilizing the Ringback Caller Database 406, the most appropriate targeted registered ringback callers can be identified and associated with particular individual or multiple Subscriber Collectives, be it Custom or Standard. Once the Collective has been implemented (the advertising messages are being broadcasted on the ringback messages), the associated ringback callers' profile data is circulated amongst the participating carrier platforms with the capacity to either facilitate the “push” of targeted ringback messages that meet the ringback caller's profile and/or account for those instances when the ideal targeted ringback caller does call a particular ringback subscriber's service (see 138 below for more detail). This same holds true for other DMC sub-type user groups.

The following offers further details into the Processes of the Supply & Demand Formation Section 421:

1. Notification postings: All parties will have electronic notification as well as individual real time admin center (connected to their User Group Admin Area) to allow for immediate updates to open orders and pricing changes to existing offers.

2. Overseeing legitimacy: Any parties involved in what can be construed as inappropriate market behavior can have certain sanctions imposed (such as suspension of membership/access). This does create a consequence for maintaining proper methodology and legitimacy of claims and commitments.

3. Eligibility: The eligibility on the part of a ringback subscriber to participate in any Subscriber Collective is function of their relative Subscriber Format Profile compared to that of the Format Profile of the Subscriber Collective and to that of the advertiser's desired “Target” Ringback Subscriber Format Profile. Eligibility for any one ringback subscriber can fluctuate/increase as the qualifying format parameters are widened to accommodate a larger potential membership to a particular Collective. More details to follow. This same holds true for other DMC sub-type user groups.

Another important subcomponent for the Ringback Coordination Center Sector is the Interactive “Floor” Section 133. In this subcomponent, ringback subscribers (Supply side) and advertisers (Demand side) are able to review online their relative availabilities, eligibilities and offers in order to arrive at a mutually satisfactory commitment to a particular Subscriber Collectives that is enabling a particular ad campaign with relative valuation. More specifically, the communication system 428 or “Big Board” is an electronic online version of a trading floor such that all parties can see all possible positions that are pertinent to them and can see how the market is driving availability and pricing. The information is provided via individual extranet admin areas, complete with electronic notification via email/or online chat of position changes. All participants have real-time input via online forms that send via email, updated position/offer requests to a centralized database that tracks the collective positions of all the participating ringback subscribers and the monetary and profile format parameter modifications on the part of the participating advertisers. In turn, these changes are posted back to the Big Board to give all participants the most current status of the Subscriber Collective being populated with members and/or being filled by committed advertisers. This same holds true for other DMC sub-type user groups.

On a more instantaneous basis, chat or message board technology such as but not limited to Instant Message can be employed in a closed group interactive communication environment whereby the Supply and Demand sides can more readily convey their interests and commitments. The data being generated through this interactive communication can be stored with the online database to maintain ongoing record of Subscriber Collectives being enabled.

The Ringback Subscriber dynamics 425: The objective of the Ringback Subscriber is to maximize their current value of its particular ringback service/air-time with its predetermined Profile/Format (In order to maintain consistency and avoid fraudulent activities, ringback subscribers can not randomly change their profile data except for expected possible changes over time such as age or income increase, and product preferences within reason). As a minimum position, an active ringback subscriber joins (via the online subscriber admin area accessing to this portion of the Invention) an active Standard Subscriber Collective awaiting a commitment from an advertiser. Bidding between advertisers for utilizing the membership in whole or in part of a particular Standard Subscriber Collective can help elevate the value for that particular Standard Subscriber Collective. Deadlines can be set to insure revenues for participating Ringback Stations. There may be minimum bids established for any particular Standard Subscriber Collective. This same holds true for other DMC sub-type user groups.

All positioning is registered via the Big Board and can be easily monitored online with communication options available to allow the Subscriber to enter their desired position offer, be it for one or more Subscriber Collective.

The 3rd Party Advertising Class Ringback dynamics 426: The goal of the advertiser is utilize the Subscriber Collective for implementing their ad campaign that has the aggregate format that comes closest to their Target Profile/Format for the least amount of cost. The advertiser initially sets the parameters for their particular Target Profile/Format that they feel are ideal for their particular ad campaign. This Target Profile/Format formulates a corresponding Custom Subscriber Collective that is listed within the Big Board to inform eligible/qualified ringback subscribers. Within the functionality of the Big Board is an automatic search of the ringback subscriber database that sends out email announcements to the closely qualifying potential participants to this Collective. Ringback subscribers can enter their interest and counter offers via the Big Board communication options. The bidding between advertisers and ringback subscriber is a consequence of price, terms and artistic options to ad production (as displayed with the Ad Showcase). This same holds true for other DMC sub-type user groups.

Other advertiser may be bidding simultaneously for the same ringback air-time, and thus the dynamic nature of the Ringback Coordination Center's Floor. As a means to populate their Collectives, advertisers may choose to widen their data sensitivity parameters to provide a greater range of qualified ringback subscriber participants, thus creating more supply for their particular Ad Campaign. A ringback subscriber whose Profile/Format is close but not yet qualifying for the current set of parameters of a particular Collective, can be placed on “Standby” position; waiting for possible broadening of the desired Profile/Format parameters set by an Advertiser. This same holds true for other DMC sub-type user groups.

An advertiser can obtain market forecast reports on the possible number of new eligible ringback subscribers (that may include those subscribers on Standby) in the event that certain parameters are indeed changed. These forecast reports access the database of those eligible and available subscribers combined with those on standby and those who are yet not near qualifying. Different scenarios can be run through the computer online using programs that extrapolate the ramifications of changing parameters, the effect on formats and the corresponding possible membership per each scenario. Online reports can be generated for the advertiser. Once a desired scenario is established, the advertiser can elect to communicate with the appropriate ringback subscribers via the Big Board communication options and invite participation for their particular Collective. This same holds true for other DMC sub-type user groups.

As another option to empower the populating of their particular Collective, an advertiser may choose to create a wider selection of potential ad content as displayed on the Ad Showcase. This new ad content can appeal to more potential ringback subscribers that have a subjective sensibility to what message is aired on their particular ringback message. This can be more important than price in some cases. Another benefit to offering a wider selection of ad content in the initial stages is that the ringback subscribers can offer valuable feedback to help refine and narrow down to the most desirable ad content. All communication regarding new ad content can be funneled through the Big Board and incorporated in the total offering made to potential subscribers. This same holds true for other DMC sub-type user groups.

The options to remunerate ringback subscribers for the use of their air-time are posted within a dedicated subcomponent of the online interface of the Ringback Coordination Center 427. In order to facilitate many of the remuneration options, it is necessary that a history of what ringback messages are being played on any given subscriber's air-time is compiled within the database of the Ringback Coordination Center. The participating carriers can provide updated database content that reflects the ringback message performance schedule implemented for a given set of ringback subscribers that include time and number of calls per ringback message content played. This information is compiled within the Ringback Coordination Center's database to allow for a complete, cross carrier monitoring of all participating ringback subscribers and their particular “play lists” (see 440 for more details). This same holds true for other DMC sub-type user groups.

The following are examples of some of the ringback subscriber remuneration options and method that also holds true for other DMC sub-type user groups:

1. Per Calls Received: An amount is paid to the ringback subscriber per every call that the particular ringback ad message is played for incoming callers. This approach takes into consideration the exposure of an ad message to ringback callers. This approach is a recognized method in a similar fashion for click-through advertising on the internet for pricing ad exposure. The advertising community also has well established formulas and bench marks for estimating value based upon exposure per person. The Coordination Center has a number of fraud preventive measures in place to help combat possible misuse of this incentive program (see 438 for more detail). The Coordination Center has the capabilities of monitoring the programming in place (what ringback messages are being played) to assure that ad exposure is being implemented

2. Per Month Flat Fee: This approach offers standardized valuation across a large Subscriber Collective whereby national statistics of number of calls per days received (approximately 8 calls) will allow an average price paid per month per each participating Ringback Subscriber; compensating each subscriber with a minimum/maximum fee per month. The Coordination Center has the capabilities of monitoring the programming in place (what ringback messages are being played) to assure that ad exposure is being implemented. While this approach does not reward those ringback stations with high caller volume, it does reduce the fraudulent tendency of the Per Call option.

3. Per Inquiry: This approach offers valuation based upon a direct measurement of the relative effectiveness of a particular campaign; ringback subscribers are compensated for actions taken by their ringback callers in response to the ringback messages being played on the subscriber's air-time. Such action on the part of the ringback callers can take various forms such as: taking steps towards obtaining more information regarding the particular ad campaign, replying to SMS text messages, using their phone pad to indicate additional content request, etc. Compensation can be dictated by the attributes of said ringback caller actions. The Ringback Coordination Center can monitor such activities by way of centralized system that obtains data from the participating Advertisers and crossed references with the performance database updates from participating carriers. Through their online admin area, participating advertisers can review performance summary data such as how many calls where made per category of ringback caller action.

4. Percentage of Sale: This approach offers the most direct compensation for the effectiveness of a particular ad campaign: ringback subscribers are compensated on a percentage of sales that are initiated by ringback callers who respond to the ringback subscribers' ad messages. When a ringback caller hears a message and buys a product being offered on a ringback subscriber's air-time, the ringback subscriber receives some predetermined percentage of said sale. The Coordination Center can track this type of transaction using Affiliate type software that ties in with online sales, cross referenced to the Ringback Subscriber and Ringback Caller involved with the particular transaction.

Note: In order to facilitate percentage of sale and even some per inquiry compensation with regard to the various degrees of carrier platform sophistication, the Invention has developed a supportive ringback caller interface (see subcomponent 750 to the Ringback Subscriber Admin Area for more information) that provides additional information for particular advertising messages heard on ringback subscribers' air-time. Facilitation of tracking transactions for percentage of sale is conducted independent of carrier performance data.

5. Combination: This approach combines a number of valuation options to arrive at the ideal manner to compensate the ringback subscriber while providing the ringback advertiser with the most verifiable offer to be made. For example, providing a Per Call price with a Per Month Flat Fee maximum fee can reduce abuse and lower cost for lower called ringback subscribers. Any number of combinations can be tracked and addressed by The Coordination Center database and transaction processing center (see 440 for more details).

6. Ringback Caller Premium: Overlaid to the various compensation listed, there is an additional premium paid when an identified ringback caller possessing the desired ringback caller Profile is involved with the call (is the calling party to the subscriber's ringback line). Predetermined additional compensation for such desired callers is factored into the total offer (see 446 for more details).

7. Traditional Valuation option: At any point, an advertiser may use more traditional industry standard methods of valuation for 3rd party advertising class ringbacks. An advertiser my offer certain remuneration based on expected ad exposure, to ringback subscribers of a single carrier. While this approach does limit the centralization of data, the Ringback Coordination Center can assist in storing the data and creating the subscriber collectives within the limited single-carrier universe of users. This data and user group can be added to other similar groupings from other carriers to facilitate an even broader mix of options and dynamic marketplace.

Note: The aforementioned valuation options can hold true for other DMC sub-type user groups.

The Order Acceptance Section 134 provides final agreed to pricing and the initial participation is locked in and committed on the part of both ringback subscribers 430 and the advertisers 431 with their particular ad campaigns. All communication/order is facilitated through the online means such as email and/or chat environment accessed via respective admin area, logged to database and reposted for confirmations. The ringback subscribers that are committing to a particular Subscriber Collectives assigned to particular ad campaigns, make their final certified orders to allow certain ringback messages to be uploaded on their particular ringback service/air-time. All details to their broadcast schedules are established/defined and the Coordination Center creates a corresponding data record that will eventually be forwarded to the respective carriers of the subscribers placing the orders. In most cases, the start of an ad campaign may begin once a certain minimum level of participation/membership is obtained. The Coordination Center has the monitoring and processes in place to communicate (via email and chat/message board) an open status to encourage new eligible ringback subscribers to join an existing Committed Subscriber Collective in motion/broadcast, up until a maximum number of participating ringback subscribers set by the advertiser is achieved. A “Waiting List” can be established to allow ringback subscribers to join when and if a vacancy is needed to be filled. Similar database management/processes monitor the membership status of Subscriber Collectives to communicate (via email/chat/message board) to the Waiting List subscribers. This same holds true for other DMC sub-type user groups.

Commit-Open Ringback Subscriber Status indicates a ringback subscriber that is committed to one ad campaign but leaves an Active status open for higher yielding Subscriber Collectives in the making. Certain guidelines dictated by the agreed terms between an advertiser and Subscriber Collective, may allow a ringback subscriber to change to another Subscriber Collective. Such circumstances such as the presence of a waiting list, or the completion of a minimum commitment to the existing Subscriber Collective, will allow a subscriber change to maximize their air-time value. Commit-Open status more easily allows a ringback subscriber to be committed to more than one ad campaign at the same time. The Coordination Center facilitates the Commit-Open status through the database management processes (maintaining subscribers availability status to be included in new Collectives), and online valuation modules that are accessed via the subscriber to provide monetary data in respect to the valuation of their current Collective commitments and prospective opportunities (see FIG. 7 details). This same holds true for other DMC sub-type user groups.

Within the Order Acceptance subcomponent, advertisers are certifying their acceptance of their financial obligation to the implementation of their ad campaign 431. Various ways can achieve guarantee of payment such as advance deposits held in escrow by the Ringback Coordination Center that establish an advertiser in good standing. The Coordination Center has the database tracking and reporting capabilities to provide protection to the subscribers as far as eliminating those advertisers who do not pay for their ad placement from using the Invention in part or in whole. See 442 for additional details. This same holds true for other DMC sub-type user groups.

Moving on to the Implementation of Ringback messages 135; in this subcomponent, the advertisement content is distributed to the appropriate Carriers associated with the committed ringback subscribers. The ad content is formatted to accommodate the technical nuances of each of the many possible Carriers represented by any particular major Subscriber Collective. Along with the content being delivered, the Carriers also receive the particular data records that indicate the scheduling times and other broadcasting details necessary to fulfill the total ad campaign being implemented by a particular Subscriber Collective and corresponding subscribers. Such data record is called the Call Performance Data Order, the details of which can be found in FIG. 12 below. This same holds true for other DMC sub-type user groups.

Turning to the Monitoring Performance Center 136; in this subcomponent, the number of airings per specific ringback ad message content is reported by the Carriers of the participating ringback subscribers to the Ringback Coordination Center and compiled into the appropriate databases, accessible by all parties. Fraudulent activities can be minimized with the proper guidelines and internal data management processes to insure quality airings (see 438 below for details).

Ringback Subscriber monitoring 435 enables ringback subscribers the ability to obtain their call performance for their committed ad campaigns. Such items as number of calls, ringback caller premium calls, the valuation of such activities and other important information is provided. This information is drawn from the collective performance data obtained from all participating and reporting Carriers and is made directly available via the online interface within the subscriber admin area (see FIG. 7 for more details).

3rd Party Advertising Class Ringback monitoring 436 enables advertisers the ability to obtain via online database interface connecting to their admin area, their call performance activity of their particular Committed Ad Campaigns in progress. Such information as number of calls made by the various ringback subscribers, performance brake down by the spectrum of demographic/geographic delineated members of their committed Subscriber Collectives, valuations of the activities, and other valuable tracking information is provided by the Coordination Center monitoring systems via online 3rd Party Advertiser Admin Area 140. This same holds true for other DMC sub-type user groups.

Ringback Caller monitoring 437 provides valuable data for the ringback callers contacting ringback subscribers' service. Such data can include the particular advertising messages they called and any product offers or other benefits that can be obtained by the ringback caller. Said data is compiled by performance information from participating carriers and accessed via the ringback caller admin area 110. See 138 and FIG. 9 for more details.

The Fraud Prevention system 438 in place offers the means to reduce possible misuse of the Invention, with, for example, the following specific measures:

1. Repeat Callers: Depending on how compensation is being provided to the ringback subscribers, discounting calls made by the same caller during a given time period may provide a disincentive to making excessive calls to earn more on a per call basis.

2. Max Calls Per Month: Setting a maximum number of calls per month being compensated can put a ceiling on the amount paid per call.

3. Sanctions: Issuing sanctions to those parties that appear to be conducting fraudulent activities will further eliminate repeat offenders.

4. Proper Comp Plan: Creating the best compensation plan can reduce problems, such as the Percentage of Sale approach.

Note: The aforementioned fraud prevention measures utilize the Coordination Center's database information and data processing capabilities. Constant data monitoring is accomplished to maintain the integrity of remuneration process.

Note: Certain DMC sub-type message will require various types of control similar to the aforementioned to ensure the utmost legitimacy.

In the detail that follows, the Transaction Processing Center 137 major subcomponent offers reconciliation and payment to all parties, providing proper credits and debits according to set prearrangements. The subsection, Tracking Performance 440 provides the necessary data collection of airings of a particular ad campaign over the number of ringback subscribers on different Carriers that comprise the Committed Ringback Subscriber Collectives. The ability for the Invention/The Ringback Coordination Center to be a centralized point of data collection and have the adaptability to interface with the various Carrier Platforms allows the tracking and evaluation of this performance data. The individual ringback subscribers have access through their admin area to review the performance data for their particular telephone line, and the advertisers have access to the collective cross-carrier data that comprises their particular committed Subscriber Collective ad campaigns (via their online admin area). Any discrepancies within the data provided can be aired and resolved before remuneration is provided. This same holds true for other DMC sub-type user groups.

Another subsection is Payment to Parties 441: In this sub-section, pre-determined payment arrangements are made depending on terms between the parties. Out of the total advertising fee being provided by the advertisers various parties will be entitled to certain compensation, such as:

1. Ringback subscribers: Ringback subscribers are compensated for their air-time. Receive the high percentage of ad fees paid, exact percentage agreed to in advance. This same holds true for other DMC sub-type user groups.

2. Carriers: Carriers are compensated for providing the ringback service capabilities to subscribers. And in some cases, Carriers can be compensated for acquisition of participating ringback subscribers, callers and advertisers (#3 below). This same holds true for other DMC sub-type user groups.

3. Member Acquisition of Record: Be it the Carrier or the Invention/The Coordination Center itself, the ability to attract and encourage the registration and participation by potential ringback subscribers has value that needs recognition in the form of additional percentage of the ad revenue. Same acquisition percentage consideration can be made and reconciled for driving new ringback callers to register and advertiser to participate. All credit can be tracked via online registration and affiliate software that tracks the origins of the promotions. This same holds true for other DMC sub-type user groups.

4. Third Parties: There may be other eligible parties such as ad agencies or Carrier acquisition partners that are deserving of certain predetermined percent of revenues. This same holds true for other DMC sub-type user groups.

5. The Ringback Coordination Center: The level in which the parties utilize the components of the Ringback Coordination Center (aside from the other aspects of the Invention like production), will dictate the percentage that goes back to the Ringback Coordination Center for rendering said services. Extensive database and communication services are all measurable and can have valuation accordingly. This same holds true for other DMC sub-type user groups.

Another sub-section is Payment Process 442: Based upon the reconciliation on the basis of the performance data and the respective terms involving the participating parties, the Ringback Coordination Center obtains the advertisers fees (using various payment means such as secured credit card transactions, direct deposit, etc.) and distributes the monies owed in a predetermined fashion. Various means of monetary distribution are available; from telephone credit to the ringback subscribers, to electronic transfer of funds. Each party involved may maintain an online account database that houses the information on the ongoing funds available. In some situation, a balance will be kept in order to allow any charge back issues to be covered in the event of product return or possible misuse/abuse of the Ringback Coordination Center. All payment information is accessible via personalized admin area dedicated to payment process 254. This same holds true for other DMC sub-type user groups.

Carriers may opt to incorporate certain aspects of the Invention/The Coordination Center into their Walled Garden/payment platform and take an active role in the payment gateway. The Carrier may provide cash payment processing in the form of credit back to the ringback subscriber owners toward their telephone invoices. The Coordination Center is actively involved maintaining database updates between the carriers and the Center in order to insure all parties are indeed properly compensated in what ever appropriate manner. This same holds true for other DMC sub-type user groups.

A final major section of the Ringback Coordination Center is the Ringback Caller Special Area 138: The highest regarded target group for any advertising ringback message is the ringback callers themselves. There are a number of means to encourage the ringback callers to register and enter their data which can be of the utmost importance to the participating advertisers. This same holds true for other DMC sub-type user groups. The following describes the many aspects of how the Coordination Center integrates ringback callers into total process and their respective ramifications/benefits:

Ringback Caller Incentives 445; The following are possible incentives and the technical methods for the Ringback Coordination Center to employ in order to attract more registrations by ringback callers:

1. Receive targeted ad offers: Data collected by the Coordination Center enables ad content to be tagged to coincide with certain ringback caller profiles. Referencing the tagged content indicator, the ringback subscribers' message cues on their relative Carrier Platform can be pre-loaded from the Ringback Coordination Center with targeted ad content that can be pushed to the appropriate targeted ringback caller upon their calling that particular ringback subscriber. In this manner, the ringback caller will experience a ringback message that is oriented to their ringback caller profile, providing a message that will be more appealing to this particular ringback caller. This same holds true for other DMC sub-type user groups. The following are some of the activities performed by the Coordination Center:
a. Data to Carriers: The Ringback Coordination Center can provide the centralized ringback caller profiles (all of whom are on various land and cellular carriers themselves), to all participating Carrier platforms. Such profile data includes the Call Performance Data Order, the details of which can be found in the section entitled Technical Outline below.
b. Content to Carriers: The committed advertisers' ad content that addresses the particular ringback caller profiles can be distributed to the Carriers by the Ringback Coordination Center, along with the tagging for proper cue identification of content. This same holds true for other DMC sub-type user groups.

2. Avoid Unwanted Ads: Ringback callers may elect to have certain ad messages eliminated or reduced from their calling patterns. Repeat ringback callers to a particular ringback subscriber may be served with new content that replaces the all ready heard messages. This option will require registration to the Ringback Coordination Center and the information disseminated to all participating Carriers. While this lowers the exposure for certain ad content, it does provide a greater level of satisfaction for the ringback message experience and more flexibility on the part of the ringback caller. This same holds true for other DMC sub-type user groups.

3. Ringback Subscriber “Friends”: In addition to the ringback subscribers providing ringback caller profile data (as they make calls to other ringback subscribers), the ringback subscribers can encourage their regular callers to support their particular ringback service/air-time by registering their ringback caller profile. As described below, the ringback subscriber can benefit financially from more registered ringback callers calling them than non-registered callers (see below). The “Friends” of their ringback service/air-time are thus supporting their favorite ringback subscribers and the whole concept in general. The Ringback Coordination Center offers the centralized data collection point for these Friends to register. This same holds true for other DMC sub-type user groups.

4. Special Product Offers: For those registered ringback callers, they can be eligible to obtain special product offers geared to their ringback caller profile. The Ringback Coordination Center can transfer by way of database update, the necessary data to the various Carriers in preparation for executing this type of promotion. Ringback callers will have access to exclusive offers, making their registration more enticing. This same holds true for other DMC sub-type user groups.

Reviewing the Ringback Subscriber Caller Premium Compensation 446, it is far more attractive for an advertiser to have registered ringback callers experiencing their ad content as opposed to relying strictly on the ringback subscriber format profile for possible connection to the ultimate listener. Therefore, a higher premium can be placed on calls completed by registered ringback callers than non-registered callers. This can be factored within the compensation orientation assigned to a particular ad campaign and their respective committed Subscriber Collective, all tracked within the Ringback Coordination Center's Transaction and Monitoring Center.

Focusing on the processes and procedures 447, the ringback caller profile and 3rd Party Advertising Class Target Profile data collected by the Ringback Coordination Center is maintained and provided to the Carriers with the utmost confidentiality. Additionally, the data transfer and database updating between the telephone switches and the Ringback Coordination Center allows for the interactive push technology to facilitate the dynamic presentation of preferred and targeted messages according to a particular ringback caller profile. Additional aspects of implementing customized messages pertain to the Call Performance Data Order, the details of which can be found in the section entitled Technical Outline below. This same holds true for other DMC sub-type user groups.

On another level of support, the ringback subscriber's online promotional/store site 750, offer the ringback caller a means to obtain more information regarding the advertised products/services (see 750 for more details).

FIG. 5 depicts the 1st Party Business Class Ringback Admin Area 160; a more comprehensive support area for all types of corporations, associations, businesses and other 1st Party Business Class Ringback candidates that seek national, regional and local promotions using their own ringback message service. The Invention assists the 1st Party Business Class Ringback user group in producing a promotional message about their business that is broadcasted on their own Ringback or of that of their employee or close associates. Subsection 500 offers more pertinent production details and information that enables 1st Party Business Class user groups to maximize their utilization of the Production Process Sector 170. Such information as detailing the various subcomponents and subsections of the Production Process Sector, the various alternative production options (Individual Company Profile Message, Corporate Company Profile Message, Company Promotional Program Message, and Infotainment Program Message), and other relevant matters that can be of benefit to the user. This same holds true for other DMC sub-type user groups.

Subsection 501 offers an online production estimator that assists the user in determining the cost associated with various production options under consideration. Once the ideal production scope and relative costs are determined, advanced payment can be made through the transactional area of the Coordination Center 137. Other parties involved with the transaction can have their contributions assessed and remunerated according to the predetermined terms.

Another subsection offers a 1st Party Business Class user access to their associated Corporate Library Database 502. This area allows the 1st Party Business Class user to review pre-produced material involving their affiliated business such as from a national franchisor that has created pre-approved material that a franchisee can utilize for their own individual ringback message. Password protected security is imposed such that each individual 1st Party Business Class user only has access to the material that has been assigned to their account. This same holds true for other DMC sub-type user groups.

Once a message is created for a particular 1st Party Business Class user, their messages can be stored for future use 503 in their own partitioned user database, access through a menu driven interface. The advantage of the Invention is that such content storage is independent of the carrier platform and therefore can be broadcast on various carriers in the case that a subscriber transfers carriers. In other cases, materials can be shared to other associated 1st Party Business Class users who have been granted permission. In additional cases, productions can be offered “for sale” back into the master pre-produced library 174 from the Production Process Sector and possibly appropriate to be listed in the Coordination Center's Ad Showcase 405. This transaction can be facilitated through the Invention's transactional processing area 137. This same holds true for other DMC sub-type user groups.

The 1st Party Business Class user may require access to the Ringback Coordination Center to create Hybrid messages (3rd Party Advertising Class and 1st Party Business Class message segments) 504. In this case, the 1st Party Business Class Ringback user can access via the Ringback Subscriber Admin Area since they will in effect become a Ringback Subscriber when they broadcast 3rd party Ad content. The Invention allows for instances of this nature and creates a dual admin access with combined feature set that encompasses both types of user groups within one main access. This same holds true for other DMC sub-type user groups.

FIG. 6 depicts the 3rd Party Advertising Class Ringback Admin Area 140; a more comprehensive support area for national, regional, local advertisers and ad agencies. The Invention assists the 3rd Party Advertising Class Ringback user group is to utilize ringback subscribers' service/air-time at the most affordable level to advertise their business or their client's business. To meet this objective, this admin area provides a number of comprehensive subsections to accommodate the most effective utilization of the Production Process Sector and the Ringback Coordination Center by an Advertiser, as follows:

The first subsection is the Formulation of Ad Campaign/Target Formats 141. This is where the ideal Demographic/Geographic profile of targeted ringback subscribers and ringback callers are determined for their particular proposed ad campaign 601. The advertiser can review existing Standard Subscriber Collectives for possible match to their desired target format or start to assemble their own Custom Subscriber Collective Format profile. There are online help-guides to assist the advertiser with their understanding in creating said target profiles, as well as examples of potentially similar products/services with their corresponding profiles. Once the profile is created with the online form, the data is stored in the advertiser's partitioned user database for utilization in the entire process. This same holds true for other DMC sub-type user groups.

The next subsection is the Advertiser's Production Center 142. It is here where Advertisers can accomplish all their production requirements in order to ready their 3rd Party Advertising Class Ringback for upload to Ringback Stations. They can obtain more specific guidelines for 3rd Party Advertising Class Ringbacks including determining how much production assistance will be needed using an online assessment guide. This guide walks the advertiser through the production options, which includes:

605—Pre-produced material available: the least amount of production occurs when there are pre-produced material/spots available from Client/Advertiser whereby no modifications are required. In some cases, even pre-produced material may require some modification that can be accomplished utilizing those necessary segments from the Production Process Sector. This same holds true for other DMC sub-type user groups.

607—Creation of Ad: More advanced production requirements occur when an entire ad spot needs to be created. The 3rd Party Advertising Class Ringback user group has the option of utilizing the self-serve aspects of the Production Process Sector or if customization is required, then there is always the direct connection to Service Providers 195 who can assist at any point. This same holds true for other DMC sub-type user groups.

610—Production Costs/payment: Upon the completing the tour of the online production guide and the advertiser has determined how much production may be required for their particular ad campaign, the advertiser can utilize an online production estimator that assists the user in determining the cost associated with various production options under consideration, including the cost associated with Service Providers 195. Advance payment can be made for production estimations through the transactional area of the Coordination Center 137. Other parties involved with the transaction can have their contributions assessed and remunerated according to the predetermined terms. It is at this point that production or modification can begin. This same holds true for other DMC sub-type user groups.

611—Accessing Production Modules: 3rd Party Advertising Class Ringback Clients/users access the necessary production modules and assistance levels to complete final ad, including Copy Center, VO, Music, Video etc. Any differences in production costs and estimated costs can be reassessed and appropriate reconciliation can be made via the Coordination Center's Transaction area 137. This same holds true for other DMC sub-type user groups.

143—Ad Storage: Once the production is complete, the 3rd Party Advertising Class Admin Area provides the database storage of 3rd Party Advertising Class Ringbacks. The production database is interconnected with all necessary dedicated user group databases for ease of transfer by way of online interface directed by user. The material created and stored can be transferred to the 1st Party Business Class Ringback Library database and to the Ringback Coordination Center Ad Showcase database under the appropriate permission by the advertiser. This same holds true for other DMC sub-type user groups.

144—Coordination Center Access: One of most important aspect of the 3rd Party Advertising Class Admin Area is access to The Ringback Coordination Center and the administration of the relative activities. It is here that an advertiser can present Custom Subscriber Collective Format Profiles and make commitments to Standard Subscriber Collectives 620 through its posting on the Big Board and through the communication assistance offered within the Coordination Center (see 410 and 417 for more details). All activities occurring within the Coordination Center in behalf of an advertiser can be accessed through the Advertiser Admin Area, including storing positions/transactions and initiating necessary communications to participating parties in the particular Center activities of an advertiser. This same holds true for other DMC sub-type user groups.

In addition, an Advertiser can monitor member enrollment for implementing Ad Campaigns 621 (see 436 for details), and receive reconciliation reports on their existing Ad Campaign activities 622 (see 137 for details). Essentially, the Advertiser Admin Area provides a summary and history via admin database and online interface of all production and ringback air-time usage involved in implementing all of an advertiser's ad campaigns. This same holds true for other DMC sub-type user groups.

FIG. 7 depicts the Ringback Subscriber Owner Admin Area 120, a comprehensive support area for any subscriber of ringback service, including 1st Party Business Class Ringbacks who seek to share their ringback message space with potential Advertisers. The Admin Area is the subscriber's interface to access the many subcomponents that facilitates the ability for the ringback subscriber user group to financially and creatively obtain the best use for their ringback message. This same holds true for other DMC sub-type user groups.

One of the main subsections is the formation and storage of their ringback subscriber's profile/format 700. A personalized private database holds various attributes that comprises the Format of their Ringback Subscriber such as: Demographics, Geographic, Product Sensitivity Index, Carrier information. This Format information is transferable and carrier independent. The Format has certain predetermined logic built in to allow for certain updating such as age and other logical changes—such as geographic relocation. There are fraud reduction measures involved to make sure a ringback subscriber profile/format does not artificially become altered in order to capture new ad revenue opportunities, but instead has a solid level of credibility for the sake of the advertising community. This same holds true for other DMC sub-type user groups.

The ringback subscriber can gain access via the admin area's online interface, to the Ringback Coordination Center 710 and administer their Coordination Center account. The ringback subscriber can review financial offers for their particular Formats and register for participation by joining the most appropriate and advantageous Subscriber Collectives. Waiting Lists (notified when a particular Subscriber Collective has openings) and Standby (notified when a particular Subscriber Collective's Format parameters are expanded to make eligible and include the standby subscriber) Status reports are provided. Electronic notifications are provided to interact with offers being made for their ringback subscriber air-time. Online valuation modules are accessed via the subscriber to provide monetary data in respect to the valuation of a subscriber's current Collective commitments and prospective opportunities. This same holds true for other DMC sub-type user groups.

Further access via the Coordination Center's Ad Showcase is available to review 3rd Party Advertising Class Ringback offers per target market 720; reviewing the messages that fit the relative ringback subscriber's Format. And once a ringback subscriber has become an Active/Committed member of a Subscriber Collective, a program schedule can be established to determine how often certain material is displayed 730. And once a ringback subscriber is engaged in an on-going ad campaign, the subscriber's history of activities and financial reconciliation is provided 740. All data is compiled through the interactions occurring in behalf of a particular subscriber within the Coordination Center, with the summary and access available via their online admin database and interface. This same holds true for other DMC sub-type user groups.

For those ringback subscriber seeking more utilization of their air-time for per-inquiry and percentage of sale compensation by advertisers, the admin area provides a “My Page” internet promotions/store mini-site 750. This template type site, adapted for each individual subscriber with certain customization options like look and naming of site, offers ringback callers the online point of presence to access any of the percentage of sale/per inquiry offers being presented on any participating ringback subscriber's air-time. Through verbal or visual references made within a subscriber's ringback message, this promo site lists the products/services that are being advertised on their ringback service, including an option to enter their own products for sale. Thus, this site operates as a mini-online store front, including the option to do secure transactions with shopping cart technology. This same holds true for other DMC sub-type user groups.

Therefore, any ringback caller who hears such messages posted to a subscriber's air-time, can be directed via message content (“if you want to receive more information or buy this product, please go to www.xys.com/mypage”) or visual prompts, to access this online promo site. This site is then connected by way of tracking software, to the fulfillment of any of the products being advertised, with credit being tracked back to the subscriber for the sale or inquiry. Each individual site is connected to all other ringback participants by way of their group activities in conjunction to the Coordination Center's Floor 133 and Transaction tracking 440. The other great advantage to this subcomponent is its complete independence to the carrier's platform limitations; the compensation can be conducted without any carrier provided performance data.

FIG. 8 depicts the Creative Consumer Ringback Admin Area 190, a comprehensive support area for consumer subscribers of Ringback service. This admin area is the interface that accesses the necessary subcomponents of the Invention that will allow the Creative Consumers to create more advanced ringback messages, beyond the levels offered by individual Carrier Platforms. The first subsection of this admin area involves the creation of a personalized database to house ringback owner information 800, such as carrier info, and possible demographic information (to the point that they are simultaneously considered registered ringback callers). This same holds true for other DMC sub-type user groups.

Extensive production option details are provided 801 in order to further empower the consumer to utilize the Production Process Sector to its fullest in their behalf (such options such combining different message segments, using video components, and utilizing existing pre-produced material). And all their created ringback messages can be stored within their online database 802, independent of their current Carrier and can be easily transferred to a new carrier if the occasion should arise. Under current situations, such transfer would be difficult, if not impossible, thereby placing an impasse for changing Carriers. In fact, there is the facility within the Admin Area to allow for the potential future ability to “sell” extensive creative ringback messages to other Creative Consumers, Advertisers and 1st Party Business Class users 803. Said transactions can be accomplished through posting on the Ringback Ad Showcase 405 and/or Pre-Produced content 174 subcomponents, with remuneration fulfillment accomplished through the Transaction Center 137. This same holds true for other DMC sub-type user groups.

FIG. 9 depicts the Ringback Caller Registration Admin Area 110, a comprehensive support area for consumers and ringback subscribers who call ringback messages. This admin area is the interface that accesses the necessary subcomponents of the Invention that will allow the ringback callers to receive more targeted and pertinent ringback messages. This same holds true for other DMC sub-type user groups.

The first subsection of this Admin Area involves the establishment of a personalized database storing the Ringback Callers Profile 901. This information guides the ringback messages being broadcast on ringback subscribers' air-time/service. Ringback caller info would be tied primarily to cellular phone numbers or restricted use land-lines (whereby, there is almost always only one caller). Such information that comprises the Caller Profile would include: Demographic, Geographic, Product Sensitivity Index—what information you seek and Carrier/Telco info. (see below and 138 for more detail) This same holds true for other DMC sub-type user groups.

Within the Admin Area, Calling Preferences can be stored and implemented 910. Such preferences include a Bypass Option 911: not hearing certain messages where appropriate, such as repeat calling of a particular number or certain advertisement content. And the preference for seeking out Top Interest preferred messages 912; messages about interested products, infotainment or monetary offers. This same holds true for other DMC sub-type user groups.

An important aspect of this Admin Area is access to the Ringback Coordination Center and the administration of Coordination Center activities 920. The Ringback Caller can officially register with the Ringback Coordination Center in order to send their data to the centralized Ringback Coordination Center Database. At that point, the ringback caller can have their Calling Preferences circulated throughout all participating Carriers, start receiving targeted ringback messages and obtain incentive offerings. Any monetary credit provided via the advertisers and ringback subscriber can be reconciled and payments applied in behalf of the ringback caller through the Transaction Center 137. This same holds true for other DMC sub-type user groups.

FIG. 10 depicts the Service Providers involved in the Invention 195; Various Service Providers extend an assortment of services that support the production, process, sales and implementation of Ringback Message industry. Such services as Copy Creation Option 1000 offers professional copywriting assistance, Voice-Over Option 1010 offers professional voice over talent, Translation services Option 1015 offers professional multi-language translation, Custom Music Option 1020 offers professional music production talent, Custom Video production Option 1030 offers professional Video production capabilities, and Custom Ad Assistance 1040 offers direct assistance throughout the production process as an overall guidance service. The aforementioned services, and any additional services that are added, can be accessed via the built in online communication options via user group admin areas, including email, online chat/message board and telephone. This same holds true for other DMC sub-type user groups.

The Subcomponent Service Provider Bidding System/Database 1060, is an online database that lists all Service Providers by category, industry affiliations and geographic orientations (where applicable). There is standardized online profile information for each Service Provider that allows a potential user to review credentials and posted past work examples. A potential user can enter a query via their particular user group admin area that searches the database for possible Service Providers that can facilitate the necessary activities. Communication can be provided to all qualified/appropriate Service Providers in good standing via special confidential emailed request for service announcement sent in behalf of the user in order to receive potential competitive bids for a certain scope of work. A user can decide and create a contract of engagement using the standardized contracts available online within their particular user group admin area. Payment can facilitated using the Transaction Center 137. This same holds true for other DMC sub-type user groups.

1050 is the Ringback Sales Associates area of the Invention that maintains records of sales credits given to those registered independent Ringback Sales Associates as they generate new accounts for 1st Party Business Class Ringback, 3rd Party Advertising Class Ringback and Creative Consumer Class Ringback, or encouraging the registration of Ringback Subscribers and Ringback Callers. This extensive admin area is designed to reflect the geographic or industry orientations of Sales Associates to provide sales coordination amongst the Associates in order to better serve general leads. This same holds true for other DMC sub-type user groups.

Specifically, the Associates can access the online database of general inquiries that come to the Invention directly, or can access leads that may come from indirect sources such as the Carriers. Such access may be designated by geographic orientation (how close an Associate is to the prospective user) or by industry orientation (what industries does a particular sales associate service). In addition, the Sales Associates may register leads and prospects as they provide outbound sales activities. Such registration is accomplished online and is entered into an online database to enable a more coordinated sales effort (eliminating contacting the same potential users). Like all other Service Providers, their compensation is factored into the appropriate sales and reconciliation within the Transactional Processing Center 137 of Ringback Coordination Center. This same holds true for other DMC sub-type user groups.

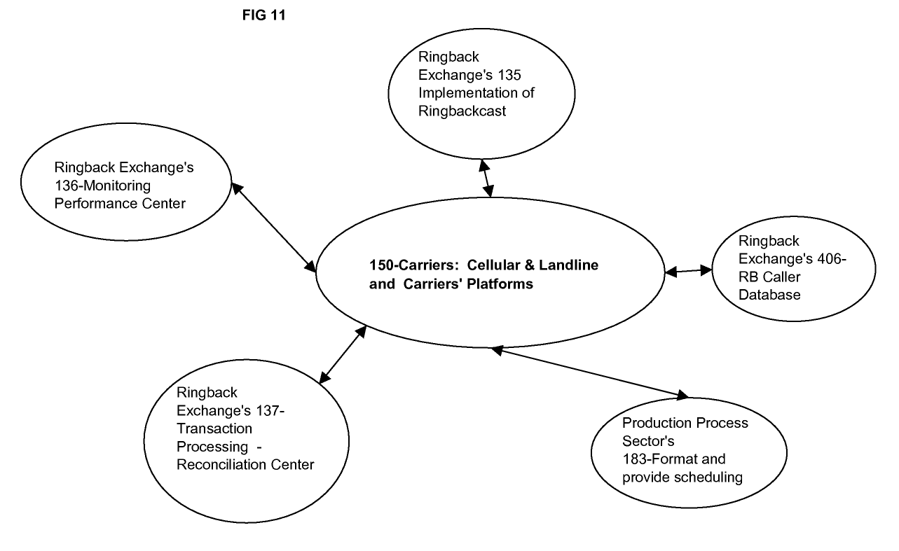

FIG. 11 depicts the Carrier/Platform 150 engagement in detail. It is important to note that the Carriers and their relative Platforms interact at various points throughout the Invention. For example:

1. The Carriers connect by way of data transfer over secure online communication to the Ringback Coordination Center as Ringback Subscriber up-load their content to their perspective Carriers via the Implementation subcomponent 135. This includes proper file formatting and sending files via preferred methods as dictated by Carriers such as FTP protocol. This same holds true for other DMC sub-type user groups.

2. The Carriers utilize the Ringback Caller Profile data provided by the Ringback Coordination Center Centralized Databases 131/406 in order to “push” certain appropriate ringback messages to the appropriate ringback callers contacting the carrier's particular ringback subscribers. This same holds true for other DMC sub-type user groups.

3. The Carriers connect by way of data transfer over secure online communication to the Ringback Coordination Center's Monitoring Performance Center 136 providing the Ringback Coordination Center with performance data on particular ringback subscriber calling activities. This same holds true for other DMC sub-type user groups.

4. The Carriers connect by way of data transfer over secure online communication to the Ringback Coordination Center's Transaction Processing/Reconciliation Center 137 in order to receive the proper financial remuneration as a percentage of Ad Revenues due to the Carriers. In some cases, the Carriers may be involved in the payment process—providing billing or issue credits to phone invoices. This same holds true for other DMC sub-type user groups.

5. The Carriers connect by way of data transfer over secure online communication to the Production Process Sector 170/183 in order to receive and uploaded final content produced in behalf of 1st Party Business Class Ringbacks, Creative Consumers, and ultimately 3rd Party Advertising Class Ringbacks by way of the Ringback Subscribers utilizing said ad content. This same holds true for other DMC sub-type user groups.

FIG. 12 depicts interaction between a user and the system according to the invention via the Internet. The user is utilizing a personal computer or other applicable two-way communication device (e.g., a PDA) for communicating with the system through user interfaces described herein. Also shown are typical elements of a personal computer, host server, and certain other aspects of the invention discussed herein.

Technical Outline: The following highlights a number of important technological features of the Invention, providing details into the facilitation/implementation of said features:

A. Custom User Environment Configuration: The Invention provides users with means to configure the way they use the various components of the Invention. The configuration allows every user to customize their preferred manner in which they access the information and functionality of the entire system to best accomplish their goals and relative activity levels, such as:

1. Production Configurations: New users to serious users can adjust how they each use the production components; from the order in which they use them, the depth of access (from a serious in depth utilization to a quick breeze through), to the classification of the Media Storage Database items. Certain User may prefer to select their music background and then test various text to speech files with the music, as opposed to creating the voice over first without music.

2. Coordination Center Configuration: Customizing communication alerts based on active level of involvement—highly active or low participation.

B. Expanded Access to Online System: The Invention's alternative interface options allow users to access the capabilities of the Invention via cellular WAP interface as well as via voice prompted call center interface:

1. WAP version of said online aspects of the Invention. Slim down version. To the extent that a WAP interface can emulate the online interface, the user can control their admin area, including conducting such production processes as up loading recording new content using such as a Flash based client application for the phone. Mobile device specific client based application.

2. Automated touch tone based call center remote admin can access certain aspect media storage database such a prompting new ringback messages for scheduled broadcast. Via Cell or Landline, this access is ideal when internet availability is difficult. This same holds true for other DMC sub-type user groups.

C. Three Main User Production “Tools”: The following highlight the 3 main empowering Tools that constitute the means in which a User best accesses media elements and facilitates payment, previewing, mixing and processing.

1. User Media Storage Database: The users private database that stores such items as purchased media elements, Uploaded Media, Self generated media elements, media produced by Service Providers and Favorite's list (data history of most favorite unpaid media elements.

2. Media Shopping Cart: Accumulates for purchase during a new production the new possible elements being purchased, programming material commitments with scheduled airing, and total pricing for the scope of production. Media Shopping Cart pushes paid items into the user's media online media mixer and media storage database for immediate use and future productions. Media Shopping Cart draws from the User database for relevant information such as current Carrier (pricing models may adjust accordingly), corporate status/affiliation (pricing implications), etc. Payment is tied to account status and payment prearrangements.

3. Online Media Mixer: Provides an online audio and visual means for the User to add different media elements together in various architectural layouts. The Mixer aspect has the options to adjust the order of any media elements (music, audio, video, etc.) as well as adjustment of the perceived volume of the associated elements (such as lowering the background music). The Media Mixer comes equipped with an assortment of template message architecture layouts to help guide the User. The Mixer utilizes items that are within the Users Media Storage Database, or being previewed before purchase from the Media Shopping Cart.

D. Important Invention Processes Technical Details: The following give particular details to various processes that compromise the Invention:
User Groups: Include all applicable potential User groups: 1st Party Business Class Admin Area 160, 3rd Party Advertising Class Ringback Admin Area 140, or Creative Consumer Admin Area 190, Ringback Caller 110, Service Providers 195, Carriers 150. This same holds true for other DMC sub-type user groups.
Media: Includes all applicable potential forms: Audio/Music, Video, Text Copy, Games, special features, etc.
Media Channel: The User can select in addition to the Ringback media channel, other DMC type means of distributing content.
Note: The selection of a particular Media Channel will determine the particular aspects of a production in order to accommodate that particular format of the DMC message content. Different length or placement of content may be needed.
Database: See Database Summary information for applicable complete listing.

1. Registration Process: Pertinent for all user groups.
Action: User registers to use the Invention via the Client Admin Area 103
Process: User is added to user database and assigned a password and user ID.
Result: User is emailed account information and is required to activate the account using code supplied in email.
Comments: By requiring account activation we are able to confirm email address and minimize system abuse.

2. Account Activation: Pertinent information for production and coordination center users
Action: User activates account or logs on to their specific User Group Admin Area
Process: User info is checked against user database. Users account history (if any) is pulled from Account History database.
Result: User section pages are generated containing user information and account history/status/settings.
Comments: User sections/pages include:
   User Contact/Billing Information—modifiable by user.
   User Account History—Previous orders, pending orders, billing history.
   User Messages—History of correspondence with support, sales, etc.
   Favorites—Displays list of ringback elements pre-selected by user as “favorites”
   Media Storage Database—Displays list of media elements purchased by user, as well as any voice over elements uploaded or recorded by the user.
   Coordination Center Sector Status data—provides necessary positions held, past and present, as well as pending fulfillment requests.

3. Accessing Production Components: For user groups utilizing the production sector.
Action: User accesses all components of media element production in the most pertinent order using their Custom User Environment Configuration.
Process: User Account History database is queried. Production options are provided and associated costs are presented. User accesses Media Shopping Cart to place order and make payment arrangements. Production options for each category of media (copy/text, voice over, music, video, games, special features) include the following:
   Select Elements from Media Storage Database—utilize existing user inventory of elements
   Purchase Pre-Produced Media Content—new pre-produced elements available via online media databases.
   Upload or Create New User Media Elements—User can upload their own content or utilize the online production capabilities for creating new media elements.
   Utilize Service Providers—3rd party Service Providers can assist at all stages of production.
Result: Depending on the chosen production path, the user will access the particular desire production options/components and begin the production process (see the following components for more details). Once the new ringback message has been approved by the user, it is submitted for final processing. This same holds true for other DMC sub-type user groups.
Comments: See FIG. 3 for details of each of the subcomponents of the production sector.

4. Mixing/Combining Existing Elements:
Action: User access online media mixer to combine and mix different media elements.
Process: User's reviews/queries and selects elements from the user's media storage database, unpaid media elements within the media shopping cart, past favorites and new user or Service Provider created media elements.
Result: Elements are loaded into the user's online media mixer, using the placement utility to organize the message architecture. The User can make adjustments to placement, substituting elements, and making certain mixing alterations such as music background volume. Users can then preview their selection.
Comments: Once the new ringback mix has been approved by the user, it is named automatically and submitted for final processing. This same holds true for other DMC sub-type user groups.

5. Previewing Pre-Produced Media Files:
Action: User “shops” for Pre-produced ringback content in various media forms. This same holds true for other DMC sub-type user groups.
Process: Databases of available ringback media elements are queried (see Database Summary, Media Databases for more specific information) This same holds true for other DMC sub-type user groups.
Result: Searchable listings of currently available ringback media elements are displayed by category/style. Each listing includes a description of the element.
Options for each item include:
   Preview—Plays element via online based media player (such as Flash™).
   Add to Favorites Database—Adds selected element to users' favorites list.
   Purchase—Adds selected element to the user's Media Shopping Cart and placeholder in user's Media Storage Database (available upon completing payment).
Comments: All pages in this section include links/menu items directing the user to the “Production Center”—also “Live Help” and “Contact Support”—it is important to note that these menu option are In-Line—i.e.: selecting any of these options, the user is able to return back to the Shopping Area—and the shopping area will be in the same state it was in when they left—this enhances the user experience. At any time during the production process, the user may elect to return to the shopping for additional elements to assist in completing their ringback production in progress. Certain media items such games and special features have platform dependent limitations for consideration.

6. Upload or Create User Media:
Action: User can upload their own media or generate online new user media.
Process: The user is prompted to select Upload or Create options.
   Upload Option—The user may upload a media file from their computer in one of the specified formats (Wave, MP3, etc.).
   Create Option One—This option allows the user to record their own media using a Flash™ based media recorder. The media recorder can record Sound and/or Video directly from the user's computer. In order to use this option, the user must have a compatible hardware setup on their computer. The Media Recorder allows the user to record their media in conjunction with pre-existing media elements. An example would be adding a voice over to an existing audio/video file, or recording video with a background music track. The user may use their telephone to add voice-over elements to pre-existing backing media.
   Create Option Two—This option employs a Text To Speech system (TTS). The user enters their text into a form and TTS is generated and the user is able to preview the results against pre-existing media elements
Result:
   Upload Option—Once the file has been uploaded, the user is asked to preview and confirm the quality of the file. After they have confirmed the file it is added to their Media Storage Database.
   Create Options One & Two—Once the user has approved their newly recorded element it is processed by the server and added to their Media Storage Database.
Comments: An service request order fulfilled by a Service Provider is handled in the same manner as the Upload Option, aside from the appropriate payment arrangements for said 3rd party assistance.

7. Editing Existing Ringback Messages:
Action: User desiring changes to their past ringback messages. This same holds true for other DMC sub-type user groups.
Process: The following are the various steps/options involving the editing process:
   User's media storage database is queried—A list of completed ringback messages is displayed.
   The user selects the ringback message they wish to edit—The user is presented with a list of media elements with the elements used for the selected ringback highlighted/selected. This same holds true for other DMC sub-type user groups.
   The user is given the option to change the elements—select an alternate purchased media element, or existing user provided media element. Or, add a new user provided media element.
Result: Once the user has made their selection, they are able to preview the results. Once they have obtained satisfactory results, the edited ringback is renamed and submitted for final production/processing.
Comments: The user may establish production templates that allow for predetermined edits and foster the ease of generating “programming” material—ever changing content.

8. Final Processing Submission & Confirmation:
Action: User submits ringback message within Media Mixer for final processing.
Process: Prior to submitting the order for final processing a Final Confirmation Screen is displayed for the User's acknowledgment. This shows the details about what is about to be submitted, displays disclaimer information, and gives the user the option to cancel their order.
Result: Following the acknowledgment by the user, the following actions occur:
   EDL Generation—An Edit Decision List is generated and stored to the User Production Database. The EDL specifies all the elements that will be combined to create the finished ringback message. It also includes the user specified name, and any user comments.
   Email Confirmation—A confirmation email is sent to the user as well as to the production support center. The confirmation email contains the information from the EDL as well as information pertaining to the estimated production time, and an order number.
   File Transfer—A new directory is created on the Production Server. The directory is named to match the order number.
   The elements referenced in the EDL are copied to the new directory on the production server along with a hard copy (.csv format) of the EDL.
Comments: Payment is made in advance according to predefined work orders created by the User prior to initiating the production steps. Any discrepancies prior to final processing can be reconciled for any differences between the initial work order and the required final production. Final Processing includes but not limited to such items as normalization, compression, equalization, and other sweetening effects.

9. Automated Final Processing:
Action: Automated final processing of ringback message. This same holds true for other DMC sub-type user groups.
Process: A script is run on the production server at set intervals (every 3-15 minutes) which checks to see if new orders are in queue. When a new order is found, a Time Stamped Production Order is generated and added to the production queue database. This same script also checks for completed orders. When a completed order is found the associated master media files is copied to the users Media Storage Database and an email notification is sent to the user letting them know that their order has been completed.
Result: Production Orders are processed sequentially based on time-stamp value. When an order is up for processing, the Production Order is read and the indicated files are loaded into the Audio Processing application (such applications include but are not limited to Cakewalk™ Sonar5™). User provided audio elements are normalized and compressed. Preprogrammed equalization and sweetening effects are applied. The elements are then mixed down to a master file and saved to the appropriate directory.
Comments: As an alternative to using the automated final processing, a User may select to use available Service Providers to accomplish more detailed final processing that can be uploaded in a manner that bypasses certain unnecessary steps of the automated final processing depending on what is accomplished by the Service Providers. The Service Providers can provide a detailed production task check list to indicate what has been completed in behalf of the User.

10. Formatting Process:
Action: The final processed ringback message is formatted to the technical specifications of the participating telephone carriers. This same holds true for other DMC sub-type user groups.
Process: The final file is transferred via internal scripting to the online formatting processing server. Each carrier's specifications dictate the file formatting processing utilized on the original final file, with new files created per different formatting requirements. All formatted files are then appropriately distributed using the method dictated by the carrier's preference such as: FTP to platform server, via attachments, hosted FTP site with notification to carriers, or VPN setup with file dump to carrier server.
Result: All carriers receive the appropriately formatted files in the appropriately delivered method. Email acknowledgment and/or data feed reply is used to confirm delivery.
Comments: Formatting is done without any involvement by the user other than the original work order and appropriate account information.

E. Summary of Main Databases:

1. Media Databases:
a. Corporate Media Database, varied level access:
   i. Corporate permission—establishes global inventory available for members of a corporation, association or business affiliation.
   ii. Members have limited access to what is already established by corporate.
b. Ad Showcase: reflects potential 3rd party advertisements
c. Pre-existing Media (This same holds true for other DMC sub-type user groups.)
   i. Music background, Voice Over, Video background, Games
   ii. Ringback media elements with classification such as: Corporate, Industry, Geographic and by Subject
   iii. Programming Ringback Elements such as Episodic or changing type content.
d. Example Database—permission varied level access.
e. User Media Storage Database; organized by classification that is most pertinent for the highest utilization by User.
   i. All media elements included for current and future ringback messages and edits, such as: Past completed ringback messages, individual elements that comprise completed ringbacks, elements created by User and Service Providers, and paid-for pre-produced elements. This same holds true for other DMC sub-type user groups.
   ii. Favorite's Database: selected media elements of interest as a reference for future possible use/purchase.
f. Carrier Media Database: For such media components as games and special features, it is necessary to access the platform dependent elements that are indigenous to each particular carrier, providing this selection to match participating ringback subscriber's technical broadcast environment. In these cases, said database will consist of limited access items, and potential examples of such for the user's preview.

2. User History of Transactions and Production Utilization:
a. User History of transactions
b. User communications history—past correspondence between PPS and user

3. Database of Invention User Groups:
a. Ringback Subscribers with My Page interface
b. Ringback Advertisers
c. Ringback Enterprise
d. Ringback Creative Consumers
e. Ringback Callers
f. Service Providers
g. Carriers
h. Ringback sales team
This all holds true for other DMC sub-type user groups.

4. Database of Coordination Center Floor Dynamics:

a. Ringback Superstations

i. Standard

ii. Customized

b. Position Status. Qualifications

i. Standby

ii. Waiting list

c. Offer Status

### Note: This same holds true for other DMC sub-type user groups.

5. Database of Order Details that go to Respective Carriers: Call Performance Data Order.

F. Call Performance Data Order Overview:

What is a Call Performance Data Order: In order to create highly customized/individualized ringback messages that correspond to particular ringback caller phone numbers as well as highly precise scheduled broadcasts of ringback messages, the Invention utilizes a multi-field database file named the Call Performance Data Order (“CPDO”). The CPDO is comprised of a number of fields and records such as but not limited to:

1. The ringback subscriber's phone number or a group of ringback subscribers' numbers used to load the customized ringback messages into their corresponding platform cues. This same holds true for other DMC sub-type user groups.

2. The specific corresponding carriers for the ringback subscribers phone numbers referenced in #1 above. This same holds true for other DMC sub-type user groups.

3. An individual phone number (either a registered and non-registered ringback caller) that corresponds to specific customized and personalized ringback messages. This ringback caller's phone number can originate from land or cellular carriers, with its own specific corresponding ringback message or messages that are played when they call the particular ringback subscriber's service number or a group of ringback subscriber numbers listed in #1 above. This same holds true for other DMC sub-type user groups.

4. Groups of ringback callers' phone numbers or area codes that correspond in whole to specific customized and personalized ringback messages. These groups of phone numbers can originate from land or cellular carriers, each group/area code having their own specific corresponding ringback message or messages that are played when members of the groups call the particular ringback subscriber's service number or a group of ringback subscriber numbers listed in #1 above. This same holds true for other DMC sub-type user groups.

5. The file identification of specifically associated ringback messages that correspond to the ringback caller phone numbers implied in #3 and 4 above. The ringback message files may be included along with the CPDO or can be resident in a platform cue in advance or later provided to the participating carriers. This same holds true for other DMC sub-type user groups.

6. Specific dates and times of day that provide scheduled broadcasts of those corresponding specific ringback message file identifications as indicated in #5 above or other associated ringback message files in cue. Said dates and times may represent a single incident of broadcast in advance, pre-programmed series of ringback messages or repeating ringback messages. This same holds true for other DMC sub-type user groups.

7. Other special features that may correspond to the individual carrier platform represented in #2 above. Such feature may be platform dependent and implemented on a carrier by carrier basis, depending on capability availability.

8. 3rd Party Advertiser Class Ringback identification number when applicable: applies to CPDO's that are being generated in behalf of said 3rd Party Advertiser Class Ringbacks. This same holds true for other DMC sub-type user groups.

9. Custom Ringback Subscriber Collective identification number when applicable: applies to the situation when 3rd Party Advertiser Class Ringback users as indicated in #8 above transfer their CPDO files to those participating members of the advertiser's corresponding Custom Ringback Subscriber Collectives. See below for more detail. This same holds true for other DMC sub-type user groups.

10. Ringback Message Category Profiles (“RMCP”) of those ringback messages referenced in #5 above or either the desired or undesired RMCP's by particular ringback callers. RMCP's consist of such fields of data that indicate the nature of the ringback messages' content such as: what type of content (advertising, programming, etc.), the product or industry represented, demographic targets, and other message indicators. Said RMCP's can be used to allow ringback callers to create and fulfill their wish list of desired ringback message content or block undesired ringback content. This same holds true for other DMC sub-type user groups.

11. Ringback callers provided blocked ringback subscriber specific numbers, groups of numbers, area code of numbers, or various levels of blocking ringback messages of business related promotions. This same holds true for other DMC sub-type user groups.

Generating CPDO: CPDO's are generated in behalf of the Invention Users such as: 1st Party Business Class Ringbacks, 3rd Party Advertiser Class Ringbacks, Ringback Subscribers, Ringback Callers and Creative Consumers through their respective User specific admin areas (160, 140, 120, 110 and 190). A CPDO can be created by the User in a number of methods, such as but not limited to:

1. A User can utilize the Invention's online data entry form that steps through the User with completing a particular CPDO (referencing the data fields as listed above). Additional information, such as phone number lists can be imported via standard database formats such Microsoft Excel or Outlook, or other standard delimited databases to assist in providing the necessary CPDO field information.

2. A User can download the Invention's standard CPDO template file available in a number of database formats (such as Microsoft Excel, Access and Outlook, as well other widely used databases), and populate the necessary information off line. The User can upload their completed CPDO, along with any client completed ringback messages or ringback components.

3. A User may opt to have a Service Provide assist them in creating a custom CPDO template that coincides with existing fields within their offline database which in turn can be more easily uploaded into the Invention's application programming interface (API).

The various CPDO's generated over time are all compiled and stored within the respective User's personal databases, affecting current scheduled broadcasting of ringback messages or other DMC sub-type messages or as part of historical record. Current CPDO's are generated to give performance detail to a particular current ringback production that is being completed and being ready to be formatted and transferred to the respective carriers. Or current CPDO's may affect ringback messages or other DMC sub-type messages already in cue within the various carrier's platform, providing changes in the calling performance indicative to each User group. Current CPDO's are formatted and transferred to the appropriate carriers for execution of call performance (see below for details). Past CPDO's are archived, acting as historic record that may be re-used for future needs.

How CPDO's Are Used: Each User group utilizes their CPDO's in various ways as outlined below:

1 Utilization of CPDO's: 1st Party Business Class Ringback User, Ringback Subscriber and Creative Consumer User groups or other DMC sub-type user groups have the following utilization of their respective CPDO's:
a. Targeted Custom Content for Specific Callers: A CPDO provides the data that identifies targeted highly personalized ringback messages to be heard by particular potential caller phone number sets. Across various carriers, a CPDO can enable such examples as personalized preambles for a large group of ringback callers such that each caller can hear their own name within the message. And within one CPDO, a number of ringback subscriber numbers can be aligned to the same or different sets of caller numbers, allowing for major corporations to provide their sales force with personalized messages to the corporation's customers. Area code groups can be identified such that geographic appropriate content is provided. Callers from various geographic locations calling in can hear most pertinent promotional information. This same holds true for other DMC sub-type user groups.
b. Custom Broadcast Timing/Schedule: Very precise timing including time of day, exact date, or repeating time cycles can be preprogrammed using the CPDO's data. Across various carriers, a CPDO can enable such examples as messages being played for certain ringback callers on their Birthdays, or special Holiday messages being played at the appropriate time. Certain sales information can be broadcast at the right moment in time. This same holds true for other DMC sub-type user groups.

2. Registered Ringback Caller Initiative: Registered Ringback Caller have the following utilization of their respective CPDO's: provides master database their wish list and no-hear list. This same holds true for other DMC sub-type user groups.
a. CPDO's provide data that conveys the “wish list” of the Ringback Caller in regards to the type of messages they do what to here. Specifically, it is the field with the CPDO called Ringback Message Category Profiles (“RMCP”) that provides the message content identification that coincide with ringback messages being offered by the potential ringback subscribers being called. RMCP's consist of such fields of data that indicate the nature of the ringback messages' content such as: what type of content (advertising, programming, etc.), the product or industry represented, demographic targets, and other message indicators. Said RMCP's can be used to allow ringback callers to create and fulfill their wish list of desired ringback message content or block undesired ringback content. This same holds true for other DMC sub-type user groups.
b. CPDO's can offer the ability for Ringback Callers to block either certain message content in general or the specific content from a particular number. The same RMCP listed above can also serve to profile content that is undesirable and can be avoided by ringback subscribers. In addition, a list of ringback subscriber phone numbers can be provided to block what ever message content is being provided by said ringback subscribers. Unwanted repeat messages can be blocked. And feedback can be provided to such blocking activity to allow for more adjustments. This same holds true for other DMC sub-type user groups.

3. 3rd Party Ringback Advertiser Initiative: A 3rd Party Ringback Advertiser can generate a CPDO that is incorporated into the parameters assigned to their particular Custom Subscriber Collective. As a component to the details encompassing the execution of their particular ad campaign, a Ringback Advertiser's CPDO is translated to the CPDO of those ringback subscribers that are participating within the Advertiser's Custom Subscriber Collective. Upon the acceptance by the ringback subscribers, The Advertiser's CPDO data file is transferred from the Advertiser's profile information stored within their database to the associated databases that comprise the participating ringback subscribers of the particular Custom Subscriber Collective in question. This same holds true for other DMC sub-type user groups.

How CPDO's Are Transferred to Carriers: The Invention provides the ability for CPDO information to be cross carrier independent, thereby delivering the appropriate portions of a given CPDO file to pertinent particular carrier. A single CPDO may be comprised of data that relates to multiple carriers. The Invention provides an internal database analyzing module that can parse/separate out the various carriers from each other and maintain the relevant records for that particular carrier. The Invention thereby acts a data depot that takes allows a single User access to all participating carriers.

Note: Carrier Platform Limitation: Not all Carrier platforms have equal capabilities for providing such customized broadcasts as linking ringback messages with particular ringback caller numbers or highly scheduled timing for broadcasting ringback messages. The Invention takes these limitations into consideration and provides the end-user with up-to-date capabilities status per platform and adapts the campaigns to the best of the abilities of the participating carriers. In the event that a CPDO can not be fulfilled as desired, the User is provided with email notification and additional adaptations can be made by the User.

Once the CPDO is separated into the various appropriate carrier specific CPDO files, the said files are then formatted accordingly to the most desired formats dictated by the participating carriers. All formatted files are then appropriately distributed using the method dictated by the carrier's preference such as: FTP to platform server, via attachments, hosted FTP site with notification to carriers, or VPN setup with file dump to carrier server.

While the foregoing invention has been shown and described with reference to its preferred embodiments; it is understood that the various embodiments herein described are for illustration of the principals of the present invention. Various modifications may be made by those skilled in the art without departing from the spirit and scope of the exemplary embodiments.

From the foregoing, it is apparent that the present invention brings a new and unique online system and method for production, storage, distribution, valuation and marketing of ringback messages and digital media content.

We claim:

1. An online system for digital media content (DMC) comprising:
a) a system portal through which a user can access the system with an interactive two-way communications device; and
b) a DMC production sector accessible by the user through the system portal, the production sector having a user controllable production module for producing multi-segment DMC.

2. The system of claim 1 in which the system portal includes a client admin area with access to:
a) a knowledge module for providing information and assistance to the user,
b) means for tracking production of the DMC by the user,
c) means for scheduling play of the DMC with one or more DMC carriers,
d) means for selection of production details, message architecture and service levels,
e) means for registration as a DMC subscriber or an advertiser user, and
f) optional means for establishing production goals for the DMC.

3. The system of claim 1 in which the production module is configured for production of a DMC comprising:
a) an initial preamble segment;
b) a prime segment flowing from the end of the preamble segment; and
c) a secondary segment flowing from the end of the prime segment.

4. The system of claim 3 in which the production module is configured for production of at least one of said segments personalized with user-uploaded content.

5. The system of claim 3 in which the production module is configured for production of at least one of said segments personalized with translated content.

6. The system of claim 1 in which the production module is further configured for production of the DMC for multiple DMC carrier platforms.

7. The system of claim 1 in which the user can select for applicability in the production module from the following:
a) media channels,
b) specific production components in the selected media channels, and
c) level of service per production component, including
i) user controlled production of the DMC,
ii) semi-automatic production of the DMC, and
iii) fully assisted production of the DMC.

8. The system of claim 7 in which the production module includes:
a) segment creation modules, with
i) an optional module for segment translation, and
ii) optional modules for selection of music, video and games segments;
b) a segment mixing module for compilation of the selected segments into the DMC; and
c) a formatting module for formatting the DMC to enable broadcast of the DMC by one or more carriers

9. The system of claim 1 in which the production sector is further configured for:
a) selection of desired media channels;
b) database storage with pre-produced DMC segments;
c) creating a message copy segment for the DMC;
d) translating the message copy segment;
e) optional application voice over talent applied to the message copy segment,
f) optional music, video and game segment selection for the DMC,
g) optionally providing specific message content and specific scheduling instructions that correspond to uploaded database information that identifies potential callers and associated attributes of said callers,
h) mixing the selected multiple segments into the DMC; and
i) final multi-carrier formatting of the DMC.

10. The system as defined in claim 1 in which said system portal includes a 1^{st} party business class admin area providing user access to custom preamble segments and a database of pre-stored content segments for production of the multi-segment DMC therefrom.

11. The system as defined in claim 1 in which said portal includes a 3^{rd} party advertising class admin area providing user access to user uploaded advertising message content segments in a database, custom preamble segments, and a database of pre-stored content segments for production of the multi-segment DMC therefrom.

12. The system as defined in claim 1 further comprising:
a) a DMC coordination sector accessible by the user through the system portal, the coordination sector having user interactive modules for valuation and distribution of the DMC.

13. The system of claim 12 further comprising:
a) database means for storing a plurality of DMC; and
b) means for distributing the stored DMC to target carriers.

14. The system of claim 12 further comprising means for acquisition and storage of profile data from at least one of a DMC subscribers group or a DMC callers group.

15. The system of claim 14 in which said acquisition means is configured for data acquisition across multiple carriers.

16. The system of claim 14 in which the valuation module is operative to evaluate and assign a monetary indicative value to the DMC airtime of said one group according to said one group's stored profile data.

17. The system of claim 16 in which said valuation module establishes an interactive marketplace between advertisers and said one group for interactive valuation of the DMC.

18. The system of claim 17 in which said valuation module includes provision for selection of profiles of interest of said one group by the advertiser, and for presentation of value-bases offers to said one group by the advertiser.

19. The system of claim 12 in which the coordination sector includes:
a) provision for online interaction between advertisers and DMC subscribers to facilitate arrival at an agreed valuation of the DMC media, and
b) provision for online implementation of a DMC advertising campaign utilizing the DMC.

20. The claim of 12 in which the coordination sector establishes a valuation center for interactive valuation of DMC between advertisers and DMC subscribers of DMC space, the valuation center including:
a) a database module for storage of:
i) DMC subscriber position, demographic and format data,
ii) optional DMC caller desired subject matter, demographic and format data, and
iii) advertisers users group data, with
a) target demographic profiles and formats of target market among the participating DMC subscribers and DMC callers, and
b) ad content data, including desired content attributes and valuation associated with the participating DMC subscriber or DMC caller,
b) a supply and demand formation module with subscriber collectives developed from the participating DMC subscribers or DMC callers;
c) an interactive module operative to achieve DMC valuation through interactive negotiating and bidding between advertisers and subscriber collectives,
d) an order acceptance module with final pricing and commitments by participating DMC subscribers and advertisers,
e) a distribution module for distribution of the DMC to the carriers associated with the committed DMC subscribers together with broadcast details for the DMC to effect an ad campaign,
f) a performance monitoring module to monitor the broadcast of the DMC by the carriers;
g) a transaction processing module for effecting agreed credits and debits between the advertisers and the DMC subscribers; and
h) an optional DMC caller module providing DMC caller incentives for participating in the ad campaign.

21. An online system for digital media content (DMC) comprising:
a) a system portal through which a user can access the system with an interactive two-way communications device; the system portal providing a multi-user interface with means for selecting user affiliation group among one of multiple available groups;
b) a DMC production sector accessible by the user through the system portal, the production sector having a user controllable production module for producing multi-segment DMC; and
c) a DMC coordination sector accessible by the user through the system portal, the coordination sector having modules for valuation and distribution of the DMC; said valuation module providing interactive communications between user groups to facilitate valuation of the DMC.

22. The system of claim 21 in which said DMC production sector further includes a file formatting and transferring module operative to provide cross-carrier adaptations of the DMC.

23. The system of claim 21 in which the available groups include:
a) a DMC subscribers group,
b) a DMC callers group,
c) a 3rd party advertisers group, and
d) a 1st party business advertisers group.

24. A method for producing and valuation of digital media content (DMC) comprising:
a) providing an online system portal through which a user can access the system with an interactive two-way communications device; the system portal providing a multi-user interface with means for selecting user affiliation group among one of multiple available groups;
b) providing a DMC production sector accessible by the user through the system portal, the production sector having a user controllable production module for producing multi-segment DMC; and
c) providing a DMC coordination sector accessible by the user through the system portal, the coordination sector having modules for valuation and distribution of the DMC; said valuation module providing interactive communications between user groups to facilitate valuation of the DMC.
